(19) United States
(12) Patent Application Publication
(10) Pub. No.: US 2023/0130867 A1
(43) Pub. Date: Apr. 27, 2023

(54) CYCLIC IMIDE RESIN COMPOSITION, LIQUID ADHESIVE, FILM, PREPREG, COPPER-CLAD LAMINATE AND PRINTED-WIRING BOARD

(71) Applicant: Shin-Etsu Chemical Co., Ltd., Tokyo (JP)

(72) Inventors: Hiroyuki IGUCHI, Annaka-shi (JP); Yoshihiro TSUTSUMI, Annaka-shi (JP); Atsushi TSUURA, Annaka-shi (JP); Yuki KUDO, Annaka-shi (JP)

(73) Assignee: Shin-Etsu Chemical Co., Ltd., Tokyo (JP)

(21) Appl. No.: 17/953,839

(22) Filed: Sep. 27, 2022

(30) Foreign Application Priority Data
Oct. 22, 2021 (JP) 2021-173075

(51) Int. Cl. C08G 73/10; C09J 179/08; C08K 5/1515

(52) U.S. Cl. CPC C08G 73/1082; C09J 179/08; C08K 5/1515

(57) ABSTRACT

Provided is such a cyclic imide resin composition where although it has a fast curability and a cured product thereof has a low relative permittivity, a low dielectric tangent and an excellent heat resistance, the composition itself has a high adhesive force. The cyclic imide resin composition contains:
(a) a cyclic imide compound represented by the following formula (1) and having a weight-average molecular weight of 2,000 to 1,000,000,

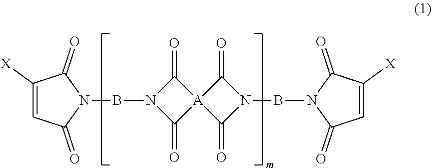

wherein A independently represents a tetravalent organic group having a cyclic structure, B independently represents a divalent hydrocarbon group that may contain a hetero atom and has not less than six carbon atoms, X independently represents a hydrogen atom or a methyl group, m is 1 to 1,000;
(b) an epoxy compound; and
(c) a polymerization initiator containing at least two types of polymerization initiators which are a radical polymerization initiator (c-1) and an anionic polymerization initiator (c-2).

### BACKGROUND OF THE INVENTION

### Field of the Invention

The present invention relates to a cyclic imide resin composition and others.

### Background Art

In recent years, as for mobile communication devices as typified by cell phones, base station devices thereof, network infrastructure devices such as servers and routers, and electronic devices such as large-scale computers, not only the speed of the signals used therein is getting higher, but the capacities of these devices themselves are also getting larger year after year. In this regard, since a high-frequency band such as the 20 GHz region will be applied to the printed-wiring boards installed in these electronic devices, materials for a printed-wiring board are now increasingly required to possess higher properties such as a low permittivity, a low dielectric tangent, a low thermal expansion rate, a high heat resistance and a low water absorption property.

As a material possibly capable of satisfying these properties, there can be listed, for example, a modified polyphenyleneether resin, a maleimide resin and an epoxy resin (JP-A-2019-1965, JP-A-2018-28044 and JP-A-2018-44065). Particularly, since a maleimide resin has a low permittivity, a low dielectric tangent and a high heat resistance, it is used as a material for a high-frequency-compatible printed-wiring board (WO2016114286 and JP-A-2020-45446).

However, a general maleimide resin has a low adhesive force, and needs to be cured at a high temperature for a long period of time in order for the properties thereof to be fully exerted; a general maleimide resin is thus not suitable for the mass production of products employing maleimide resins.

### SUMMARY OF THE INVENTION

Thus, it is an object of the present invention to provide such a cyclic imide resin composition where although it has a fast curability and a cured product thereof has a low relative permittivity, a low dielectric tangent and an excellent heat resistance, the composition itself has a high adhesive force.

The inventors of the present invention diligently conducted a series of studies to solve the abovementioned problems, and completed the invention as follows. That is, the inventors found that a cyclic imide resin composition described below can achieve the aforementioned object.

Specifically, the present invention is to provide the following cyclic imide resin composition and others.

[1]

A cyclic imide resin composition containing:
(a) a cyclic imide compound represented by the following formula (1) and having a weight-average molecular weight of 2,000 to 1,000,000,

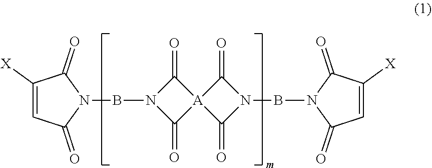

wherein A independently represents a tetravalent organic group having a cyclic structure, B independently represents a divalent hydrocarbon group that may contain a hetero atom and has not less than six carbon atoms, X independently represents a hydrogen atom or a methyl group, m is 1 to 1,000;
(b) an epoxy compound; and
(c) a polymerization initiator containing at least two types of polymerization initiators which are a radical polymerization initiator (c-1) and an anionic polymerization initiator (c-2).
   [2]

The cyclic imide resin composition according to [1], wherein the organic group represented by A in the formula (1) is any one of the tetravalent organic groups expressed by the following structural formulae:

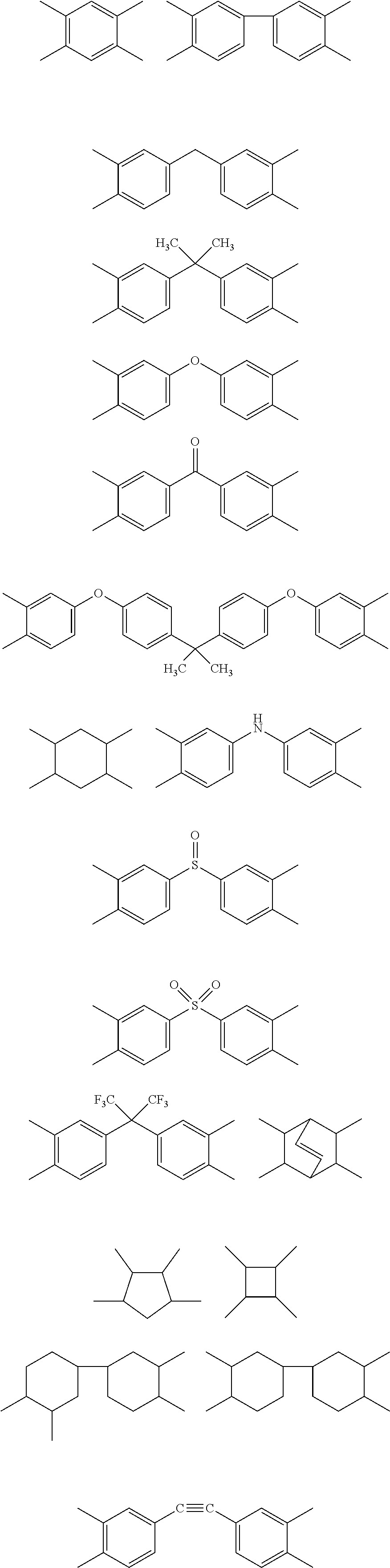

wherein bonds that are yet unbonded to substituent groups are to be bonded to carbonyl carbons forming cyclic imide structures in the formula (1).

[3]

The cyclic imide resin composition according to [1], wherein the cyclic imide compound as the component (a) is a cyclic imide compound represented by the following formula (2):

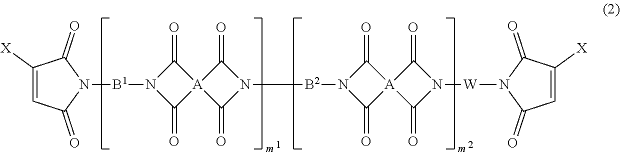

wherein A independently represents a tetravalent organic group having a cyclic structure; B¹ independently represents an alkylene group that may contain a hetero atom and has 6 to 60 carbon atoms, or a dimer acid frame-derived divalent hydrocarbon group; B² independently represents an arylene group that may contain a hetero atom and has 6 to 30 carbon atoms; X independently represents a hydrogen atom or a methyl group; W is B¹ or B²; m¹ is 1 to 500; m² is 0 to 500.

[4]

The cyclic imide resin composition according to [3], wherein B¹ in the formula (2) is selected from a dimer acid frame-derived divalent hydrocarbon group and any of the groups represented by the following structural formulae:

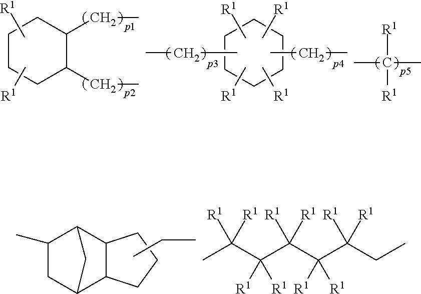

wherein each R¹ independently represents a hydrogen atom, or a linear or branched alkyl group having 1 to 20 carbon atoms; p¹ and p² each represent a number of not smaller than 5, and may be either identical to or different from each other; p³ and p⁴ each represent a number of not smaller than 0, and may be either identical to or different from each other; p⁵ represents a number of 6 to 60; bonds that are yet unbonded to substituent groups are to be bonded to nitrogen atoms forming cyclic imide structures in the formula (2).

[5]

The cyclic imide resin composition according to [3] or [4], wherein the arylene group that may contain a hetero atom and has 6 to 30 carbon atoms, as represented by B² in the formula (2), is a group expressed by any of the following structural formulae:

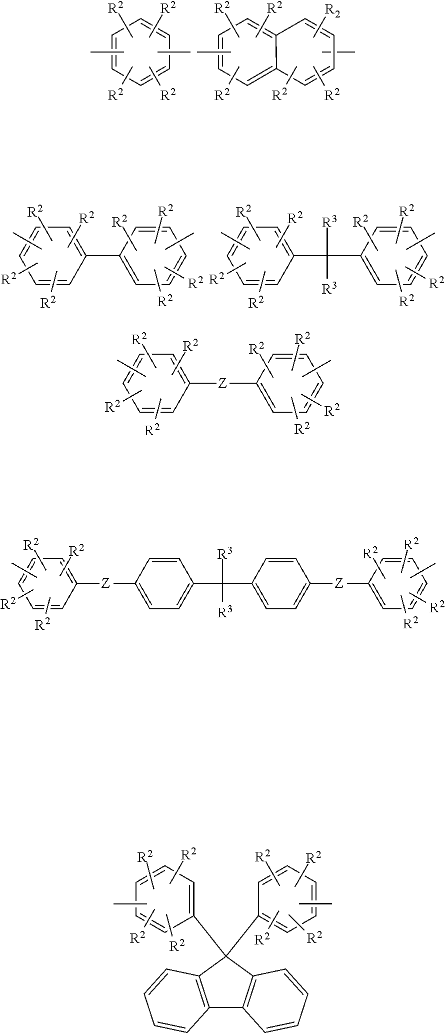

wherein each R² independently represents a hydrogen atom, a halogen atom or an alkyl group having 1 to 6 carbon atoms; each R³ independently represents a hydrogen atom, a halogen atom, a methyl group or a trifluoromethyl group; Z represents an oxygen atom, a sulfur atom or a methylene group; bonds that are yet unbonded to substituent groups are to be bonded to nitrogen atoms forming cyclic imide structures in the formula (2).

[6]

The cyclic imide resin composition according to any one of [3] to [5], wherein the cyclic imide compound as the component (a) is a cyclic imide compound with m² in the formula (2) being 0.

[7]

The cyclic imide resin composition according to any one of [1] to [6], wherein the epoxy compound as the component (b) has an epoxy equivalent of not smaller than 300 g/eq.

[8]

The cyclic imide resin composition according to any one of [1] to [7], wherein the radical polymerization initiator as the component (c-1) is an organic peroxide.

[9]

The cyclic imide resin composition according to any one of [1] to [8], wherein the anionic polymerization initiator as the component (c-2) is at least one compound selected from imidazole compounds and organic phosphorus compounds.

[10]

A liquid adhesive containing the cyclic imide resin composition according to any one of [1] to [9].

[11]

A film containing the cyclic imide resin composition according to any one of [1] to [9].

[12]

A prepreg containing the cyclic imide resin composition according to any one of [1] to [9].

[13]

A copper-clad laminate containing the prepreg according to [12].

[14]

A printed-wiring board containing the copper-clad laminate according to [13].

While the cyclic imide resin composition of the present invention has a fast curability and a cured product thereof has a low relative permittivity, a low dielectric tangent and an excellent heat resistance, the composition itself has a high adhesive force. Thus, the cyclic imide resin composition of the present invention is suitable for use in, for example, an adhesive, a prepreg, a copper-clad laminate, a printed-wiring board, a base material film for a flexible printed-wiring board, a coverlay film, an adhesive for a coverlay film, an adhesive for heat dissipation, an electromagnetic wave shield and a semiconductor encapsulation material.

### DETAILED DESCRIPTION OF THE INVENTION

The cyclic imide resin composition of the present invention is described in detail hereunder.

### (a) Cyclic Imide Compound Represented by the Following Formula (1) and Having a Weight-Average Molecular Weight of 2,000 to 1,000,000

A cyclic imide compound as a component (a) is a main component of the cyclic imide resin composition of the present invention, and is represented by the following formula (1). Since the cyclic imide resin composition of the present invention contains the component (a), a cured product of this resin composition will be able to exhibit a lower relative permittivity, a lower dielectric tangent and a higher strength.

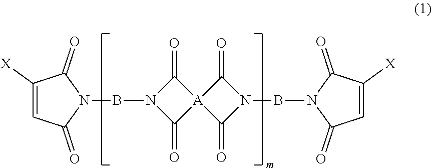

In the formula (1), A independently represents a tetravalent organic group having a cyclic structure. B independently represents a divalent hydrocarbon group that may contain a hetero atom and has not less than six carbon atoms. X independently represents a hydrogen atom or a methyl group. m is 1 to 1,000.

Here, the organic group represented by A in the formula (1) is independently a tetravalent organic group having a cyclic structure; particularly, it is preferred that this organic group be any one of the tetravalent organic groups expressed by the following structural formulae.

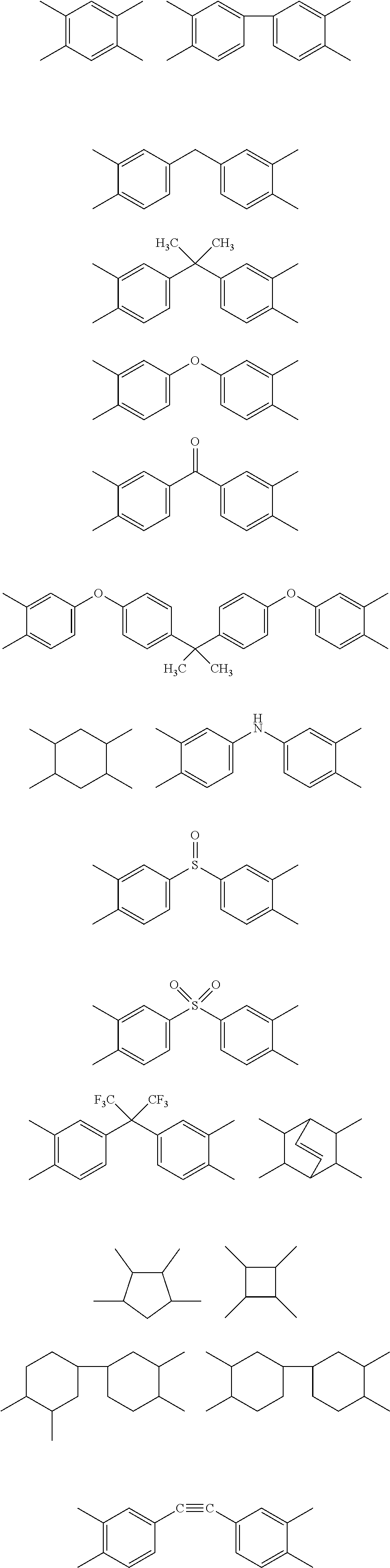

Bonds in these structural formulae that are yet unbonded to substituent groups are to be bonded to carbonyl carbons forming cyclic imide structures in the formula (1).

Further, B in the formula (1) independently represents a divalent hydrocarbon group that may contain a hetero atom and has not less than six carbon atoms; it is preferred that B represent a divalent hydrocarbon group that may contain a hetero atom and has 6 to 20 carbon atoms.

As B, preferred are an alkylene group that may contain a hetero atom and has 6 to 60 carbon atoms, a dimer acid frame-derived divalent hydrocarbon group, or an arylene group that may contain a hetero atom and has 6 to 30 carbon atoms.

As an alkylene group that may contain a hetero atom and has 6 to 60 carbon atoms, there may be listed those similar to those exemplified as B¹ in a later-described formula (2); more specifically, the groups represented by any of the following structural formulae serve as particularly preferable examples.

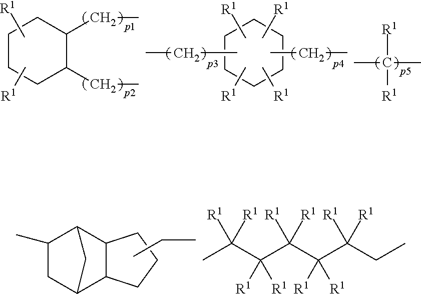

Bonds in these structural formulae that are yet unbonded to substituent groups are to be bonded to nitrogen atoms forming cyclic imide structures in the formula (1).

In the above formulae, each R¹ independently represents a hydrogen atom, or a linear or branched alkyl group having 1 to 20 carbon atoms; preferably a hydrogen atom, or a linear or branched alkyl group having 1 to 10 carbon atoms; more preferably a hydrogen atom, or a linear alkyl group having 1 to 10 carbon atoms.

In the above formulae, each of p¹ and p² represents a number of not smaller than 5, preferably a number of 5 to 12, more preferably a number of 6 to 10; p¹ and p² may be either identical to or different from each other.

Each of p³ and p⁴ represents a number of not smaller than 0, preferably a number of 0 to 4, more preferably a number of 0 to 2; p³ and p⁴ may be either identical to or different from each other.

In the above formulae, p⁵ represents a number of 6 to 60, preferably a number of 6 to 40, more preferably a number of 6 to 20.

Further, as an arylene group that may contain a hetero atom and has 6 to 30 carbon atoms, there may be listed those similar to those exemplified as B² in a later-described formula (2); more specifically, the groups expressed by any of the following structural formulae serve as particularly preferable examples.

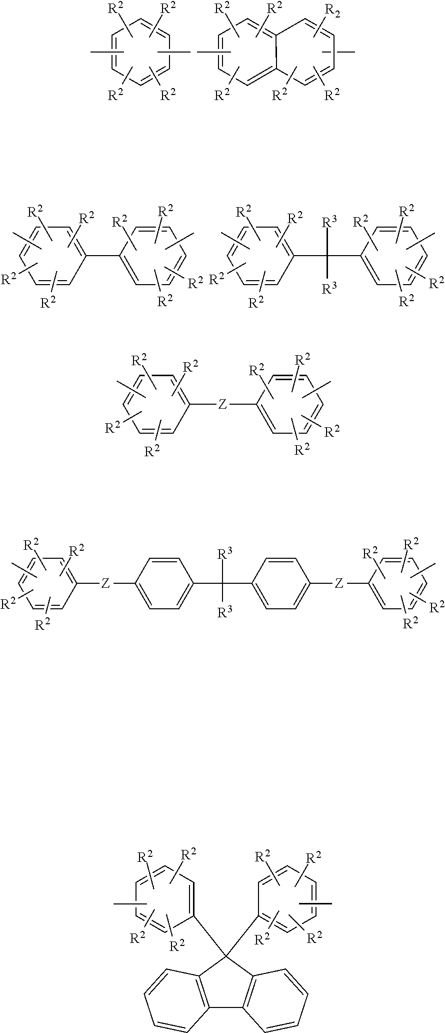

Bonds in these structural formulae that are yet unbonded to substituent groups are to be bonded to nitrogen atoms forming cyclic imide structures in the formula (1).

In the above formulae, each R² independently represents a hydrogen atom, a halogen atom or an alkyl group having 1 to 6 carbon atoms; preferably a hydrogen atom or an alkyl group having 1 to 6 carbon atoms; more preferably a hydrogen atom, a methyl group or an ethyl group.

In the above formulae, each R³ independently represents a hydrogen atom, a halogen atom, a methyl group or a trifluoromethyl group; preferably a hydrogen atom, a methyl group or a trifluoromethyl group.

In the above formulae, Z represents an oxygen atom, a sulfur atom or a methylene group; preferably an oxygen atom or a sulfur atom.

X in the formula (1) represents a hydrogen atom or a methyl group; preferably a hydrogen atom.

m in the formula (1) is a number of 1 to 1,000, preferably a number of 1 to 900.

As the cyclic imide compound represented by the formula (1), a cyclic imide compound represented by the following formula (2) is more preferred.

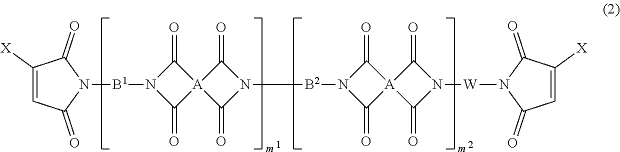

In the formula (2), A independently represents a tetravalent organic group having a cyclic structure. B¹ independently represents an alkylene group that may contain a hetero atom and has 6 to 60 carbon atoms, or a dimer acid frame-derived divalent hydrocarbon group. B² independently represents an arylene group that may contain a hetero atom and has 6 to 30 carbon atoms. X independently represents a hydrogen atom or a methyl group. W is B¹ or B². m¹ is 1 to 500. m² is 0 to 500.

As the cyclic structure-containing tetravalent organic group represented by A in the formula (2), there may be listed groups similar to those exemplified as A in the formula (1).

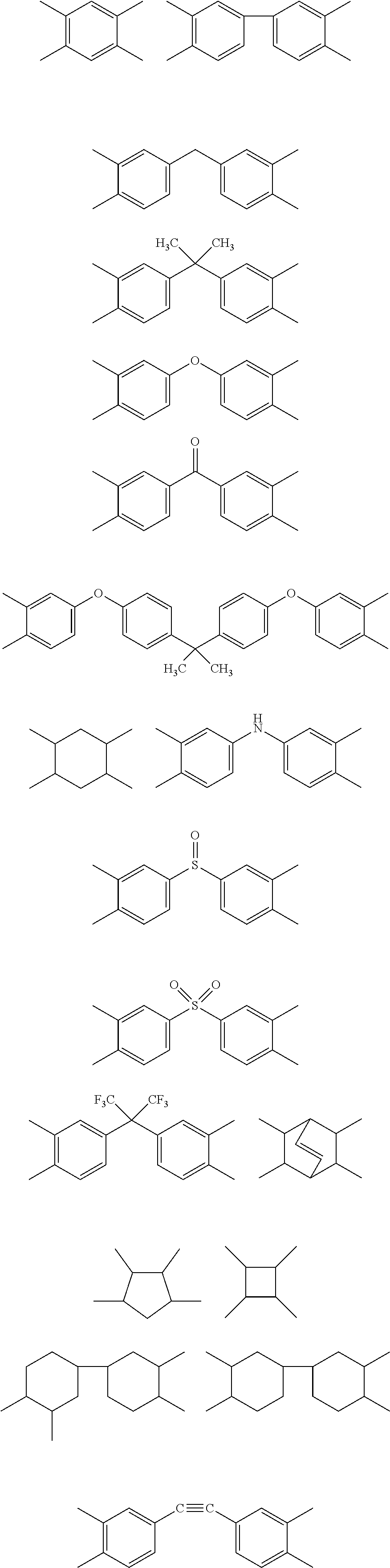

Bonds in these structural formulae that are yet unbonded to substituent groups are to be bonded to carbonyl carbons forming cyclic imide structures in the formula (2).

As the alkylene group represented by B¹ in the formula (2) which is an alkylene group that may contain a hetero atom and has 6 to 60 carbon atoms, preferred is an alkylene group that may contain a hetero atom and has 8 to 50, preferably 8 to 40 carbon atoms. Further, the alkylene group of B¹ that may contain a hetero atom and has 6 to 60 carbon atoms may have any of a linear, branched and cyclic structures, or be a group having several of these structures in combination. More specifically, as the alkylene group of B¹ that may contain a hetero atom and has 6 to 60 carbon atoms, the groups represented by any of the following structural formulae serve as particularly preferable examples.

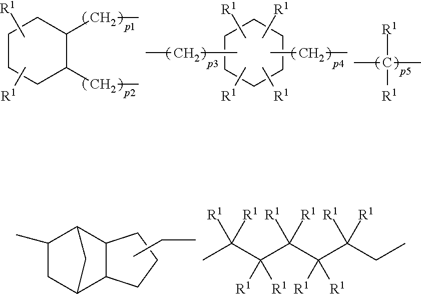

Bonds in these structural formulae that are yet unbonded to substituent groups are to be bonded to nitrogen atoms forming cyclic imide structures in the formula (2).

In the above formulae, each R¹ independently represents a hydrogen atom, or a linear or branched alkyl group having 1 to 20 carbon atoms; preferably a hydrogen atom, or a linear or branched alkyl group having 1 to 10 carbon atoms; more preferably a hydrogen atom, or a linear alkyl group having 1 to 10 carbon atoms.

In the above formulae, each of p¹ and p² represents a number of not smaller than 5, preferably a number of 5 to 12, more preferably a number of 6 to 10; p¹ and p² may be either identical to or different from each other.

Each of p³ and p⁴ represents a number of not smaller than 0, preferably a number of 0 to 4, more preferably a number of 0 to 2; p³ and p⁴ may be either identical to or different from each other.

In the above formulae, p⁵ represents a number of 6 to 60, preferably a number of 6 to 40, more preferably a number of 6 to 20.

The dimer acid frame-derived divalent hydrocarbon group represented by B¹ in the formula (2) is a group derived from a dimer acid as a liquid fatty acid whose main component is a dicarboxylic acid having 36 carbon atoms, where the dimer acid is produced by dimerizing an unsaturated fatty acid having 18 carbon atoms and whose raw material is a natural substance such as a vegetable fat or oil. A dimer acid frame refers to a structure obtained by eliminating carboxy groups from the aforementioned dimer acid. Thus, the dimer acid frame is not a single frame, but has multiple structures. The following structures serve as examples of the dimer acid frame.

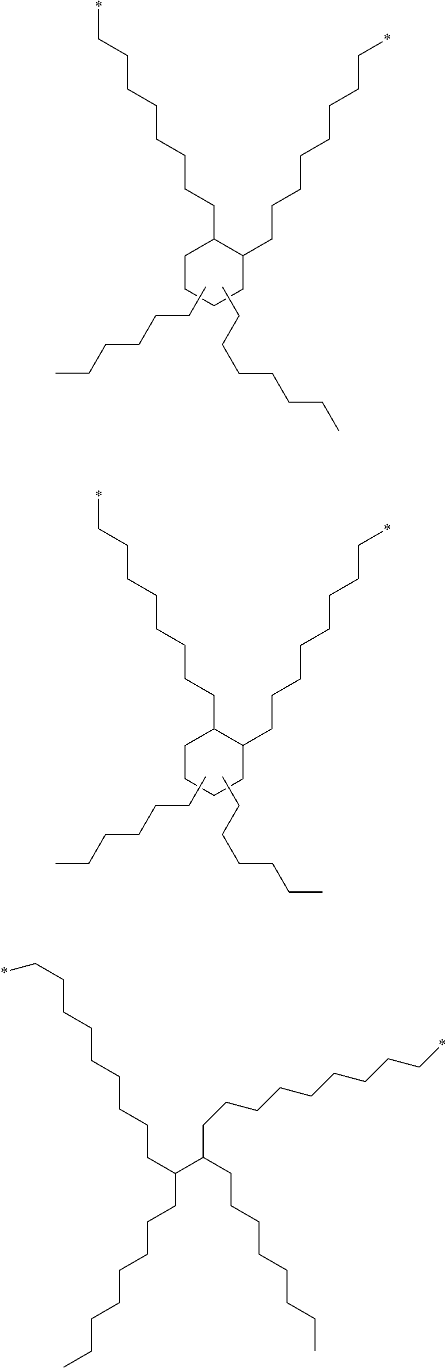

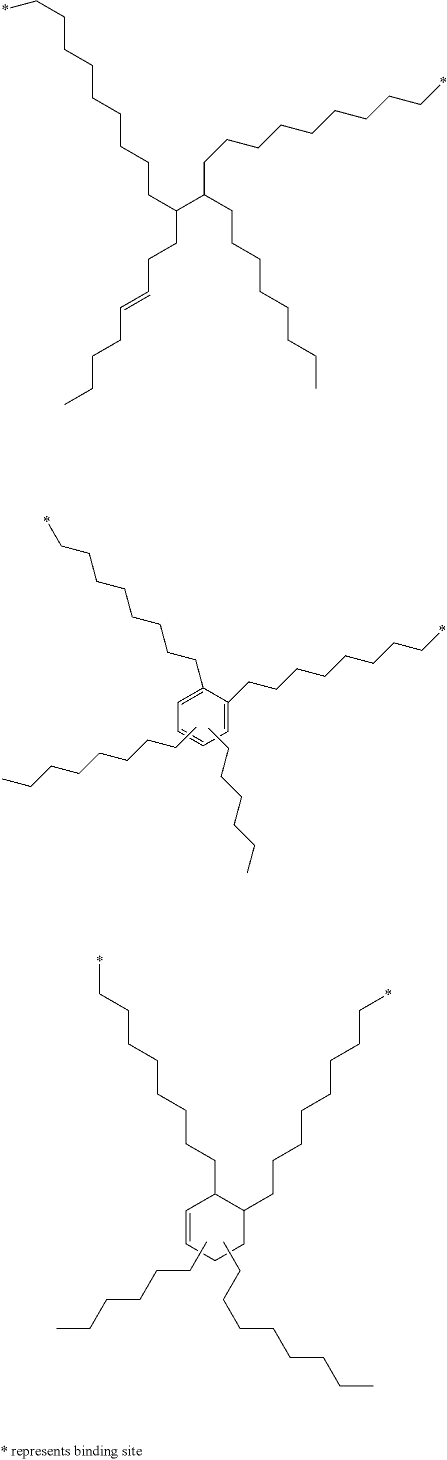

As described above, since the dimer acid frame has multiple structures, the dimer acid frame-derived divalent hydrocarbon group in this specification may be expressed as a group represented by the following formula (3) in terms of an average structure thereof.

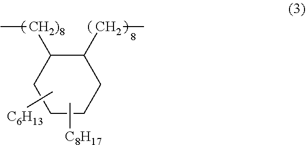

In the formula (2), as the arylene group of B² that may contain a hetero atom and has 6 to 30 carbon atoms, preferred is an arylene group that may contain a hetero atom and has 10 to 30, preferably 20 to 30 carbon atoms. The arylene group of B² that may contain a hetero atom and has 6 to 30 carbon atoms is a divalent group obtained by eliminating, from an aromatic hydrocarbon, two hydrogen atoms bonded to the carbon atoms composing the aromatic ring. This aromatic hydrocarbon includes the following compounds.

Monocyclic or polycyclic aromatic hydrocarbon

Compound with two or more independent monocyclic or polycyclic aromatic hydrocarbons being bonded together via a single bond or a divalent organic group

More specifically, as the arylene group of B² that may contain a hetero atom and has 6 to 30 carbon atoms, the groups represented by any of the following structural formulae serve as particularly preferable examples.

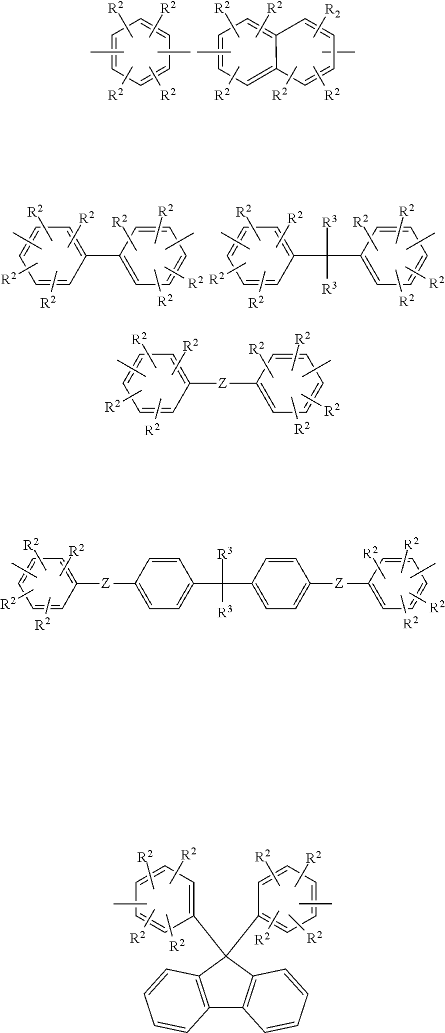

Bonds in these structural formulae that are yet unbonded to substituent groups are to be bonded to nitrogen atoms forming cyclic imide structures in the formula (2).

In the above formulae, each R² independently represents a hydrogen atom, a halogen atom or an alkyl group having 1 to 6 carbon atoms; preferably a hydrogen atom or an alkyl group having 1 to 6 carbon atoms; more preferably a hydrogen atom, a methyl group or an ethyl group.

In the above formulae, each R³ independently represents a hydrogen atom, a halogen atom, a methyl group or a trifluoromethyl group; preferably a hydrogen atom, a methyl group or a trifluoromethyl group.

In the above formulae, Z represents an oxygen atom, a sulfur atom or a methylene group; preferably an oxygen atom or a sulfur atom.

X in the formula (2) represents a hydrogen atom or a methyl group; preferably a hydrogen atom.

In the formula (2), m¹ is 1 to 500, preferably 1 to 300.

In the formula (2), m² is a number of 0 to 500, preferably 0 to 300.

In the formula (2), when m²=0, the cyclic imide compound as the component (a) is that represented by the following formula (2-1).

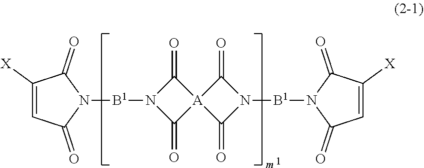

(In the formula (2-1), A, B¹, X and m¹ are similar to those in the formula (2).)

It is particularly preferable to use the cyclic imide compound represented by the formula (2-1) as the cyclic imide compound of the component (a), because the cured product of the resin composition will exhibit a low relative permittivity and a low dielectric tangent.

The weight-average molecular weight (Mw) of the cyclic imide compound as the component (a) is 2,000 to 1,000,000, preferably 2,500 to 500,000, more preferably 3,000 to 300,000, even more preferably 3,500 to 100,000. When such weight-average molecular weight is smaller than 2,000, the cured product of the cyclic imide resin composition will exhibit a low strength; when such weight-average molecular weight is larger than 1,000,000, the reactivity of the cyclic imide groups at the terminals will decrease such that it will be difficult for the composition to cure sufficiently.

The weight-average molecular weight (Mw) mentioned in this specification refers to a weight-average molecular weight measured by GPC under the following conditions, with polystyrene being used as a reference substance.

GPC measurement conditions
Developing solvent: Tetrahydrofuran
Flow rate: 0.6 mL/min

### Column: TSK Guardcolumn Super H-L

TSK gel Super H4000 (6.0 mmI.D.×15 cm×1)

TSK gel Super H3000 (6.0 mmI.D.×15 cm×1)

TSK gel Super H2000 (6.0 mmI.D.×15 cm×2)

(All manufactured by TOSOH CORPORATION)

Column temperature: 40° C.
Sample injection volume: 20 μL (sample concentration: tetrahydrofuran solution of 0.5% by mass)
Detector: Refractive index detector (RI)

There are no particular restrictions on a method for producing the cyclic imide compound (e.g. maleimide compound, citraconimide compound) as the component (a). For example, the cyclic imide compound may be produced by at first reacting an acid anhydride with diamine so as to synthesize an amine-terminated compound, and then reacting such amine-terminated compound with an excess maleic anhydride or citraconic anhydride.

Examples of the acid anhydride include pyromellitic anhydride, maleic anhydride, succinic anhydride, 4,4′-carbonyldiphthalic anhydride, 4,4′-diphthalic anhydride, 4,4′-sulfonyldiphthalic anhydride, 4,4′-oxydiphthalic anhydride, and 4,4′-(4,4′-isopropylidenediphenoxy)diphthalic anhydride. Depending on for example an intended purpose or use, any one of these acid anhydrides may be used alone, or two or more of them may be used in combination. In terms of electric properties of the cyclic imide compound, it is preferred that the acid anhydride be pyromellitic anhydride, 4,4′-oxydiphthalic anhydride and/or 4,4′-(4,4′-isopropylidenediphenoxy)diphthalic anhydride.

Examples of the diamine include 2,2-bis(4-(4-aminophenoxy)phenyl)propane, 4,4′-diamino-3,3′-dimethyldiphenylmethane, 4,4′-diamino-3,3′-diethyldiphenylmethane, 4,4′-diaminodiphenyl ether, 4,4′-diamino-3,3′,5,5′-tetraethyldiphenylmethane, tetramethyl-1,3-bis(3-aminopropyl)disiloxane, bis[4-(4-aminophenoxy)phenyl]sulfone, 4,4′-diaminodiphenylmethane, 1,3-bis(4-aminophenoxy)benzene, 1,12-diaminododecane, 1,10-diaminodecane, dimer diamine, octyl diamine, 1,3-di(aminomethyl)cyclohexane, 1-amino-4-(aminomethyl)cyclohexane, 1,3-diaminoadamantane, isophoronediamine, 2,4,4-trimethylhexane-1,6-diamine and 2-methylpentyl diamine. Depending on for example an intended purpose or use, any one of these diamines may be used alone, or two or more of them may be used in combination. In terms of adhesiveness and electric properties of the cyclic imide compound, it is preferred that the diamine be an aliphatic diamine, where 1,12-diaminododecane, dimer diamine, isophoronediamine and 2,4,4-trimethylhexane-1,6-diamine are more preferred.

A commercially available product may be used as the cyclic imide compound as the component (a). Examples of such commercially available product include BMI-1400, BMI-2500, BMI-3000 (all produced by Designer Molecules Inc.).

It is preferred that the equivalent of the cyclic imide groups in the component (a) be 200 to 700 g/eq, more preferably 250 to 650 g/eq, even more preferably 300 to 600 g/eq, particularly preferably 350 to 550 g/eq. It is preferable when the equivalent is within these ranges, because the cured product of the resin composition will exhibit a low relative permittivity and a low dielectric tangent.

In the composition of the present invention, it is preferred that the component (a) be contained in an amount of 40 to 98 parts by mass, more preferably 50 to 95 parts by mass, even more preferably 60 to 90 parts by mass, per 100 parts by mass of a resin component. Here, the resin component refers to a total amount of components (a) to (c), and also includes the amounts of a component (d) and other additives if they are contained; however, the contained amounts of an inorganic filler and an organic filler are not included in the resin component.

### (b) Epoxy Compound

In the case of the cyclic imide resin composition of the present invention, since there is contained an epoxy compound as a component (b), not only the adhesiveness and curability of the resin composition can be improved, but the heat resistance and moisture absorption resistance of the cured resin composition can also be improved.

Examples of the epoxy compound as the component (b) include a bisphenol A type epoxy resin; a bisphenol F type epoxy resin; a biphenol type epoxy resin such as a 3,3′,5,5′-tetramethyl-4,4′-biphenol type epoxy resin and 4,4′-biphenol type epoxy resin; a biphenol novolac type epoxy resin; a biphenyl aralkyl type epoxy resin; a phenoxy type epoxy resin; a phenol novolac type epoxy resin; a cresol novolac type epoxy resin; a bisphenol A novolac type epoxy resin; a naphthalenediol type epoxy resin; a trisphenylol methane type epoxy resin; a tetrakisphenylol ethane type epoxy resin; a phenol dicyclopentadiene novolac type epoxy resin; and an epoxy resin obtained by hydrogenating the aromatic ring of a phenol dicyclopentadiene novolac type epoxy resin. Among these examples, in terms of adhesiveness, reactivity and electric property, preferred are those having an epoxy equivalent of 300 to 20,000 g/eq, more preferably 400 to 5,000 g/eq. Depending on for example an intended purpose or use, any one of these epoxy compounds may be used alone, or two or more of them may be used in combination.

In the composition of the present invention, it is preferred that the component (b) be contained in an amount of 0.1 to 30 parts by mass, more preferably 1 to 20 parts by mass, even more preferably 3 to 10 parts by mass, per 100 parts by mass of the component (a) in the composition of the present invention. When the amount of the component (b) is within these ranges, the adhesiveness and curability of the resin composition can be improved while maintaining a low relative permittivity and low dielectric tangent of the cured product thereof.

### (c) Polymerization Initiator

A component (c) is used to cure the resin composition.

The component (c) contains two types of polymerization initiators which are a radical polymerization initiator as a component (c-1) and an anionic polymerization initiator as a component (c-2). Here, by adding the component (c-1), a fast curability can be improved; and by adding the component (c-2), the adhesiveness can be improved.

As the component (c-1), there may be employed, for example, a thermal radical polymerization initiator.

Examples of such thermal radical polymerization initiator include organic peroxides such as methylethylketone peroxide, methylcyclohexanone peroxide, methylacetoacetate peroxide, acetylacetone peroxide, 1,1-bis(t-butylperoxy)3,3,5-trimethylcyclohexane, 1,1-bis(t-hexylperoxy)cyclohexane, 1,1-bis(t-hexylperoxy)3,3,5-trimethylcyclohexane, 1,1-bis(t-butylperoxy)cyclohexane, 2,2-bis(4,4-di-t-butylperoxycyclohexyl)propane, 1,1-bis(t-butylperoxy)cyclododecane, n-butyl-4,4-bis(t-butylperoxy)valerate, 2,2-bis(t-butylperoxy)butane, 1,1-bis(t-butylperoxy)-2-methylcyclohexane, t-butyl hydroperoxide, p-menthane hydroperoxide, 1,1,3,3-tetramethylbutyl hydroperoxide, t-hexylhydroperoxide, dicumylperoxide, 2,5-dimethyl-2,5-bis(t-butylperoxy)hexane, α,α′-bis(t-butylperoxy)diisopropylbenzene, t-butylcumylperoxide, di-t-butylperoxide, 2,5-dimethyl-2,5-bis(t-butylperoxy)hex-3-yne, isobutyryl peroxide, 3,5,5-trimethylhexanoyl peroxide, octanoyl peroxide, lauroyl peroxide, cinnamic acid peroxide, m-toluoyl peroxide, benzoyl peroxide, diisopropyl peroxydicarbonate, bis(4-t-butylcyclohexyl)peroxydicarbonate, di-3-methoxybutyl peroxydicarbonate, di-2-ethylhexyl peroxydicarbonate, di-sec-butyl peroxydicarbonate, di(3-methyl-3-methoxybutyl)peroxydicarbonate, di(4-t-butylcyclohexyl)peroxydicarbonate, α,α′-bis(neodecanoylperoxy)diisopropylbenzene, cumyl peroxyneodecanoate, 1,1,3,3-tetramethylbutyl peroxyneodecanoate, 1-cyclohexyl-1-methylethyl peroxyneodecanoate, t-hexyl peroxyneodecanoate, t-butyl peroxyneodecanoate, t-hexyl peroxypivalate, t-butyl peroxypivalate, 2,5-dimethyl-2,5-bis(2-ethylhexanoylperoxy)hexane, 1,1,3,3-tetramethylbutylperoxy-2-ethylhexanoate, 1-cyclohexyl-1-methylethylperoxy-2-ethylhexanoate, t-hexylperoxy-2-ethylhexanoate, t-butylperoxy-2-ethylhexanoate, t-butyl peroxyisobutyrate, t-butyl peroxymaleic acid, t-butyl peroxylaurate, t-butylperoxy-3,5,5-trimethylhexanoate, t-butyl peroxyisopropyl monocarbonate, t-butylperoxy-2-ethylhexyl monocarbonate, 2,5-dimethyl-2,5-bis(benzoylperoxy)hexane, t-butyl peroxyacetate, t-hexyl peroxybenzoate, t-butylperoxy-m-toluoylbenzoate, t-butylperoxybenzoate, bis(t-butylperoxy)isophthalate, t-butylperoxyallyl monocarbonate, and 3,3′,4,4′-tetra(t-butylperoxycarbonyl)benzophenone; and azo compounds such as 2,2′-azobis(N-butyl-2-methylpropionamide), 2,2′-azobis(N-cyclohexyl-2-methylpropionamide), 2,2′-azobis[N-(2-methylpropyl)-2-methylpropionamide], 2,2′-azobis[N-(2-methylethyl) methylpropionamide], 2,2′-azobis(N-hexyl-2-methylpropionamide), 2,2′-azobis(N-propyl methylpropionamide), 2,2′-azobis(N-ethyl-2-methylpropionamide), 2,2′-azobis[2-methyl-N-(2-hydroxyethyl)propionamide], 2,2′-azobis[N-(2-propenyl)-2-methylpropionamide], 2,2′-azobis {2-methyl-N-[1,1-bis(hydroxymethyl)-2-hydroxyethyl]propionamide}, 2,2′-azobis[N-(2-propenyl)-2-methylpropionamide], and dimethyl-1,1′-azobis(1-cyclohexanecarboxylate). Among these examples, in terms of preservation stability, organic peroxides are preferred, where dicumylperoxide, t-butylcumylperoxide and di-t-butylperoxide are more preferred.

As the component (c-2), there may be employed, for example, a thermal anionic polymerization initiator. Examples of such thermal anionic polymerization initiator include imidazole compounds such as 2-methylimidazole, 2-ethylimidazole, 2-phenylimidazole, 2-ethyl-4-methylimidazole, 2-undecylimidazole, 1-cyanoethyl-2-ethyl-4-methylimidazole, and 2,4-diamino-6-[2-(2-methyl-1-imidazolyl)ethyl]-1,3,5-triazine; amine compounds such as triethylamine, triethylenediamine, 2-(dimethylaminomethyl)phenol, 1,8-diaza-bicyclo[5.4.0]undecene-7, tris(dimethylaminomethyl)phenol, and benzyldimethylamine; and organic phosphorus compounds such as triphenylphosphine, tributylphosphine, trioctylphosphine, tetrabutylphosphonium hexafluorophosphate, tetrabutylphosphonium tetraphenylborate, tetrabutylphosphonium acetate, tetraphenylphosphonium tetraphenylborate, tetraphenylphosphonium bromide, tetrabutylphosphonium bromide, tetrabutylphosphonium laurate, tetraphenylphosphonium hydrogen phthalate, bis(tetraphenylphosphonium)dihydrogen pyromellitate, and bis(tetrabutylphosphonium)dihydrogen pyromellitate. Among these examples, imidazole compounds and organic phosphorus compounds are preferred, where more preferred are 1-cyanoethyl-2-ethyl-4-methylimidazole, 2,4-diamino-6-[2-(2-methyl-1-imidazolyl)ethyl]-1,3,5-triazine, triphenylphosphine, tetrabutylphosphonium laurate, tetraphenylphosphonium hydrogen phthalate, bis(tetraphenylphosphonium)dihydrogen pyromellitate and bis(tetrabutylphosphonium)dihydrogen pyromellitate.

As for each of the radical polymerization initiator (c-1) and the anionic polymerization initiator (c-2), there may be used one kind thereof alone, or two or more kinds thereof in combination. While there are no particular restrictions on the amount of each of the components (c-1) and (c-2) added, it is preferred that each of these components be added in an amount of 0.01 to 10 parts by mass, more preferably 0.1 to 5 parts by mass, even more preferably 0.3 to 3 parts by mass, per 100 parts by mass of the component (a). When the amount of each of the components (c-1) and (c-2) is within these ranges, the resin composition can be sufficiently cured without negatively impacting the properties of the resin composition.

In the present invention, a dielectric tangent at 10 GHz is preferably not higher than 0.01, more preferably not higher than 0.005, even more preferably 0.0001 to 0.003. Other components

Adhesiveness Imparting Agent

The resin composition of the present invention may contain an adhesiveness imparting agent if necessary, for the purpose of imparting an adhesiveness or tackiness (pressure-sensitive adhesiveness). As such adhesiveness imparting agent, there may be listed, for example, an acrylic resin, a urethane resin, a phenolic resin, a terpene resin and a silane coupling agent. Among them, an acrylic resin and a silane coupling agent are preferred in terms of imparting an adhesiveness; a terpene resin is preferred in terms of imparting a tackiness (pressure-sensitive adhesiveness).

There are no particular restrictions on the acrylic resin, examples of which may include lauryl acrylate, stearyl acrylate, isostearyl acrylate, phenoxyethyl acrylate, phenoxydiethylene glycol acrylate, tetrahydrofurfuryl acrylate, isobornyl acrylate, 2-acryloyloxyethyl phthalic acid, 2-acryloyloxyethyl acid phosphate, polyethylene glycol diacrylate, dimethylol tricyclodecane diacrylate, trimethylol propane triacrylate, dipentaerythritol hexaacrylate, dioxane glycol diacrylate, 9,9-bis[4-(2-hydroxyethoxy)phenyl]fluorene diacrylate, lauryl methacrylate, phenoxyethyl methacrylate, phenoxydiethylene glycol methacrylate, tetrahydrofurfuryl methacrylate, isobornyl methacrylate, 2-methacryloyloxyethyl phthalic acid, 2-methacryloyloxyethyl acid phosphate, polyethylene glycol dimethacrylate, and dimethylol tricyclodecane dimethacrylate.

There are no particular restrictions on the terpene resin, examples of which may encompass homopolymers of terpenes including monoterpenes such as α-pinene, β-pinene, dipentene and limonene, sesquiterpenes such as cedrene and farnesene, and diterpenes such as abietic acid; aromatic modified terpene resins as copolymers of the aforementioned terpenes and aromatic vinyl compounds such as styrene and α-methylstyrene; and terpene phenolic resins as copolymers of the aforementioned terpenes and phenols such as phenol, cresol, hydroquinone, naphthol and bisphenol A. Further, there may also be used, for example, a hydrogenated terpene resin obtained by hydrogenating any of these terpene resins.

There are no particular restrictions on the silane coupling agent, examples of which may include silane coupling agents such as n-propyltrimethoxysilane, n-propyltriethoxysilane, n-octyltrimethoxysilane, n-octyltriethoxysilane, phenyltrimethoxysilane, phenyltriethoxysilane, methyltrimethoxysilane, methyltriethoxysilane, 2-[methyl(polyethyleneoxy)propyl]-trimethoxysilane, methoxytri(ethyleneoxy)propyltrimethoxysilane, 3-glycidyloxypropyltrimethoxysilane, 3-glycidoxypropyltrimethoxysilane, 3-aminopropyltrimethoxysilane, N-phenyl-3-aminopropyltrimethoxysilane, 3-mercaptopropyltrimethoxysilane, 3-(methacryloyloxy)propyltrimethoxysilane, 3-isocyanatopropyltriethoxysilane, and 3-isocyanatopropyltrimethoxysilane.

There are no particular restrictions on the amount of the adhesiveness imparting agent contained; it is preferred that the adhesiveness imparting agent be added in an amount of 0.1 to 20 parts by mass, more preferably 0.5 to 10 parts by mass, even more preferably 1 to 5 parts by mass, per 100 parts by mass of the component (a). When the amount of the adhesiveness imparting agent is within these ranges, the adhesive force or tack strength of the resin composition can be further improved without modifying the mechanical properties thereof. Antioxidant

There are no particular restrictions on an antioxidant, examples of which may include phenolic antioxidants such as n-octadecyl-3-(3,5-di-t-butyl-4-hydroxyphenyl)propionate, n-octadecyl-3-(3,5-di-t-butyl-4-hydroxyphenyl)acetate, neododecyl-3-(3,5-di-t-butyl-4-hydroxyphenyl)propionate, dodecyl-β-(3,5-di-t-butyl-4-hydroxyphenyl)propionate, ethyl-α-(4-hydroxy-3,5-di-t-butylphenyl)isobutyrate, octadecyl-α-(4-hydroxy-3,5-di-t-butylphenyl)isobutyrate, octadecyl-α-(4-hydroxy-3,5-di-t-butyl-4-hydroxyphenyl)propionate, 2-(n-octylthio)ethyl-3,5-di-t-butyl-4-hydroxyphenyl acetate, 2-(n-octadecylthio)ethyl-3,5-di-t-butyl-4-hydroxyphenyl acetate, 2-(n-octadecylthio)ethyl-3-(3,5-di-t-butyl-4-hydroxyphenyl)propionate, 2-(2-stearoyloxyethylthio)ethyl-7-(3-methyl-5-t-butyl-4-hydroxyphenyl)heptanoate, 2-hydroxyethyl-7-(3-methyl-5-t-butyl-4-hydroxyphenyl)propionate, and pentaerythritoltetrakis[3-(3,5-di-t-butyl-4-hydroxyphenyl)propionate]; sulfur-based antioxidants such as dilauryl-3,3′-thiodipropionate, dimyristyl-3,3′-thiodipropionate, distearyl-3,3′-thiodipropionate, ditridecyl-3,3′-thiodipropionate, and pentaerythrityltetrakis(3-laurylthiopropionate); and phosphorus-based antioxidants such as tridecyl phosphite, triphenylphosphine, tris(2,4-di-t-butylphenyl)phosphite, 2-ethylhexyl diphenyl phosphite, diphenyl tridecyl phosphite, 2,2-methylenebis(4,6-di-t-butylphenyl)octyl phosphite, distearyl pentaerythritol diphosphite, bis(2,6-di-t-butyl-4-methylphenyl)pentaerythritol diphosphite, and 2-[[2,4,8,10-tetrakis(1,1-dimethylethyl)dibenzo[d,f][1,3,2]dioxaphosphepin-6-yl]oxy]-N,N-bis[2-[[2,4,8,10-tetrakis(1,1-dimethylethyl)dibenzo[d,f][1,3,2]dioxaphosphepin-6-yl]oxy]-ethyl]ethanamine.

There are no particular restrictions on the amount of the antioxidant contained; it is preferred that the antioxidant be added in an amount of 0.00001 to 5 parts by mass, more preferably 0.0001 to 4 parts by mass, even more preferably 0.001 to 3 parts by mass, per 100 parts by mass of the component (a). When the amount of the antioxidant is within these ranges, oxidation of the resin composition can be prevented without modifying the mechanical properties thereof.

### Flame Retardant

There are no particular restrictions on a flame retardant, examples of which may include a phosphorus-based flame retardant, a metal hydrate, a halogen-based flame retardant and a guanidine-based flame retardant. Examples of a phosphorus-based flame retardant include red phosphorus; ammonium phosphates such as monoammonium phosphate, diammonium phosphate, triammonium phosphate and ammonium polyphosphate; inorganic nitrogen-containing phosphorus compounds such as guanidine phosphate and phosphoric amide; phosphoric acid; phosphine oxide; triphenyl phosphate; tricresyl phosphate; trixylenyl phosphate; cresyldiphenyl phosphate; cresyl di-2,6-xylenyl phosphate; resorcinol bis(diphenylphosphate); 1,3-phenylene bis(di-2,6-xylenylphosphate); bisphenol A-bis(diphenylphosphate); 1,3-phenylene bis(diphenylphosphate); divinyl phenylphosphonate; diallyl phenylphosphonate; bis(1-butenyl)phenylphosphonate; phenyl diphenylphosphinate; methyl diphenylphosphinate; phosphazene compounds such as bis(2-allylphenoxy)phosphazene and dicresyl phosphazene; melamine phosphate; melamine pyrophosphate; melamine polyphosphate; melam polyphosphate; melem polyphosphate; 9,10-dihydro-9-oxa-10-phosphaphenanthrene-10-oxide; and 10-(2,5-dihydroxyphenyl)-9,10-dihydro-9-oxa-10-phosphaphenanthrene-10-oxide. Examples of a metal hydrate include aluminum hydroxide hydrate and magnesium hydroxide hydrate. Examples of a halogen-based flame retardant include hexabromobenzene, pentabromotoluene, ethylenebis(pentabromophenyl), ethylenebistetrabromophthalimide, 1,2-dibromo-4-(1,2-dibromoethyl)cyclohexane, tetrabromocyclooctane, hexabromocyclododecane, bis(tribromophenoxy)ethane, brominated polyphenylene ether, brominated polystyrene, and 2,4,6-tris(tribromophenoxy)-1,3,5-triazine. Examples of a guanidine-based flame retardant include guanidine sulfamate and guanidine phosphate.

There are no particular restrictions on the amount of the flame retardant contained; it is preferred that the flame retardant be added in an amount of 0.01 to 20 parts by mass, more preferably 0.05 to 10 parts by mass, even more preferably 0.1 to 5 parts by mass, per 100 parts by mass of the component (a). When the amount of the flame retardant is within these ranges, a flame retardancy can be imparted to the resin composition without modifying the mechanical properties thereof.

### Inorganic Filler

There are no particular restrictions on an inorganic filler, examples of which may include metal oxides such as silica, titanium dioxide, yttrium oxide, aluminum oxide, magnesium oxide, zinc oxide and beryllium oxide; metal nitrides such as boron nitride, aluminum nitride and silicon nitride; carbon-containing particles such as silicon carbide particles, diamond particles and graphene particles; hollow particles such as silica balloons (hollow silica), carbon balloons, alumina balloons and aluminosilicate balloons; elemental metals such as gold, silver, copper, palladium, aluminum, nickel, iron, cobalt, titanium, manganese, zinc, tungsten, platinum, lead and tin; alloys such as solder, steel and stainless steel; magnetic metal alloys such as stainless steel, Fe—Cr—Al—Si alloy, Fe—Si—Al alloy, Fe—Ni alloy, Fe—Cu—Si alloy, Fe—Si alloy, Fe—Si—B (—Cu—Nb) alloy, Fe—Si—Cr—Ni alloy, Fe—Si—Cr alloy, and Fe—Si—Al—Ni—Cr alloy; and ferrites such as hematite (Fe₂O₃), magnetite (Fe₃O₄), Mn—Zn-based ferrite, Ni—Zn-based ferrite, Mg—Mn-based ferrite, Zr—Mn-based ferrite, Ti—Mn-based ferrite, Mn—Zn—Cu-based ferrite, barium ferrite, and strontium ferrite. Any one of these inorganic fillers may be used alone, or two or more of them may be used in combination.

The linear expansion coefficient of the cured product of the resin composition can be lowered, and the thermal conductivity thereof can be raised, by adding a metal oxide, metal nitride and/or carbon-containing particles; the relative permittivity, dielectric tangent, density and the like of the cured product of the resin composition can be lowered by adding hollow particles; the electric conductivity, thermal conductivity and the like of the cured product of the resin composition can be raised by adding a metal and/or alloy; and an electromagnetic wave absorption capability can be imparted to the cured product of the resin composition by adding ferrites.

There are no particular restrictions on the shape of the inorganic filler, examples of which may include a spherical shape, scale-like shape, flake-like shape, needle-like shape, stick-like shape and oval shape, of which preferred are a spherical shape, scale-like shape, flake-like shape, oval shape and stick-like shape, more preferred are a spherical shape, scale-like shape, flake-like shape and oval shape.

There are no particular restrictions on the primary particle size of the inorganic filler; it is preferred that the primary particle size thereof be 0.05 to 500 μm, more preferably 0.1 to 300 μm, even more preferably 1 to 100 μm, in terms of a median diameter measured by a laser diffraction particle size distribution measurement device. It is preferable when the primary particle size is within these ranges, because it is easy to uniformly disperse the inorganic filler in the resin composition, and the inorganic filler will not be precipitated, separated or unevenly distributed with time.

There are no particular restrictions on the amount of the inorganic filler added; it is preferred that the inorganic filler be added in an amount of 5 to 3,000 parts by mass, more preferably 10 to 2,500 parts by mass, even more preferably 50 to 2,000 parts by mass, per 100 parts by mass of the component (a) in the composition of the present invention. When the amount of the inorganic filler is within these ranges, the function(s) of the inorganic filler can be fully exhibited while maintaining the strength of the resin composition.

Organic Filler

There are no particular restrictions on an organic filler, examples of which may include thermoplastic resin particles such as particles of an acrylic-butadiene copolymer, styrene-butadiene copolymer, acrylonitrile-styrene-butadiene copolymer and acrylic block copolymer; carbon fibers; cellulose fibers; a silicone powder; an acrylic powder; a polytetrafluoroethylene powder; a polyethylene powder; and a polypropylene powder. Any one of these organic fillers may be used alone, or two or more of them may be used in combination.

There are no particular restrictions on the shape of the organic filler, examples of which may include a spherical shape, fibrous shape, flake-like shape, needle-like shape, stick-like shape and oval shape, of which preferred are a spherical shape, fibrous shape, flake-like shape, oval shape and stick-like shape, more preferred are a spherical shape, fibrous shape, flake-like shape and oval shape.

There are no particular restrictions on the primary particle size of the organic filler; it is preferred that the primary particle size thereof be 0.05 to 500 μm, more preferably 0.1 to 300 μm, even more preferably 1 to 100 μm, in terms of a median diameter measured by a laser diffraction particle size distribution measurement device. It is preferable when the primary particle size is within these ranges, because it is easy to uniformly disperse the organic particles in the resin composition, and the organic particles will not be precipitated, separated or unevenly distributed with time.

There are no particular restrictions on the amount of the organic filler added; it is preferred that the organic filler be added in an amount of 1 to 400 parts by mass, more preferably 5 to 200 parts by mass, even more preferably 10 to 100 parts by mass, per 100 parts by mass of the component (a) in the composition of the present invention. When the amount of the organic filler is within these ranges, the strength of the resin composition can be improved.

### Production Method

As a method for producing the resin composition of the present invention, there may be employed for example a method where the components (a) to (c) and other optional additives are to be mixed using a planetary mixer (by INOUE MFG., INC.), a mixer called “THINKY CONDITIONING MIXER” (by THINKY CORPORATION) or the like; more preferably a method where an organic solvent (e.g. cyclopentanone, cyclohexanone, mesitylene, anisole, dibutyl ether, diphenyl ether, 1,4-dioxane, N,N-dimethylformamide, N,N-dimethylacetamide, dimethyl sulfoxide, N-methylpyrrolidone) is further added to the aforementioned ingredients before performing mixing. By adding an organic solvent, the viscosity of the resin composition can be lowered, and mixing can be performed more evenly. The resin composition can be obtained by distilling away the organic solvent under a reduced pressure after mixing; if the resin composition is used as, for example, a liquid adhesive or a prepreg, the mixture can then be used as it is without distilling away the organic solvent, or with the concentration thereof being adjusted to a desired value.

### Liquid Adhesive

The cyclic imide resin composition of the present invention may also be used as a liquid adhesive in a manner such that the composition is to be dissolved in the abovementioned organic solvent, and the solution thus prepared is then applied or sprayed onto an adherend before being heated and dried.

There are no particular restrictions on an application or spraying method; a dispenser, a sprayer or the like may be used.

There are no particular restrictions on a heating and drying method; the method may be selected depending on the volatility of the solvent used. For example, the composition may be dried by performing heating at 40 to 120° C. for 1 to 10 min.

### Film

The cyclic imide resin composition of the present invention may also be used as a film in a manner such that the composition is to be dissolved in the abovementioned organic solvent, and the solution thus prepared is then applied to a film having a mold releasability so as to form a thin film thereon before being heated and dried.

As the film having a mold releasability, though it is optimized depending on the type of the cyclic imide resin composition, there may be listed for example fluorine-based resin films such as a fluorine-based resin-coated PET (polyethylene terephthalate) film, a silicone resin-coated PET film, a PTFE (polytetrafluoroethylene) film, an ETFE (poly(ethylene-tetrafluoroethylene)) film, and a CTFE (polychlorotrifluoroethylene) film. Due to these films having a mold releasability, it will be easy to handle the film containing the cyclic imide resin composition of the present invention (also referred to as “cyclic imide resin film,” or simply as “film” hereunder), and foreign matters such as dust can be prevented from adhering thereto.

There are no particular restrictions on the thickness of the cyclic imide resin film; it is preferred that the thickness thereof be 1 to 2,000 μm, more preferably 1 to 500 μm, even more preferably 10 to 300 μm. When the thickness of the cyclic imide resin film is smaller than 1 μm, it will be difficult to attach the film to a substrate or the like; and when the thickness of the cyclic imide resin film is larger than 2,000 μm, it will be difficult for the film to maintain its flexibility as a film. Further, if containing an inorganic filler or organic filler, it is preferred that the film thickness be twice the particle size of the filler or larger, more preferably three times the particle size of the filler or larger, even more preferably 5 to 1,000 times the particle size of the filler. It is preferable when the film thickness is within these ranges, because concavities and convexities caused by the inorganic filler will not occur easily.

Here, as a method for using the cyclic imide resin film, there may be employed for example a method where after peeling off a resin film having a mold releasability (if such resin film is provided), the cyclic imide resin film will then be sandwiched between adherends before being cured by thermocompression bonding. There, it is preferred that the cyclic imide resin film be heated at 100 to 300° C. for 1 min to 4 hours, more preferably at 120 to 250° C. for 2 min to 3 hours, even more preferably at 150 to 200° C. for 3 min to 2 hours. Further, a pressure for bonding is preferably 0.01 to 100 MPa, more preferably 0.05 to 80 MPa, even more preferably 0.1 to 50 MPa.

The film of the present invention may be previously semi-cured (B-staged) by heat and light. There are no particular restrictions on a method for turning the film into B-stage; for example, after applying the cyclic imide resin composition, B-stage can be achieved by performing heating at 80 to 200° C. for 1 to 30 min, or by performing irradiation with a light of 200 to 400 nm at 10 to 3,000 mJ/cm².

### Prepreg

The cyclic imide resin composition of the present invention may also be used as a prepreg in a manner such that the composition is to be dissolved in the abovementioned organic solvent, and a fiber base material is then impregnated with the solution thus prepared before being heated and dried.

As the fiber base material, there can be employed a known fiber base material used in laminates. For example, there may be listed inorganic fibers such as an E glass fiber, S glass fiber, T glass fiber, NE glass fiber and Q glass (quartz glass) fiber; and organic fibers such as polyethylene fiber, polyester fiber, polyamide fiber and polytetrafluoroethylene fiber. Any one of these fibers may be used alone, or two or more of them may be used in combination. Particularly, in terms of dielectric properties, an inorganic fiber is preferred, of which more preferred are a T glass fiber, NE glass fiber and Q glass fiber.

There are no particular restrictions on the thickness of the fiber base material; it is preferred that the thickness thereof be 5 to 500 μm, more preferably 10 to 100 μm, even more preferably 20 to 80 pun. When the thickness of the fiber base material is within these ranges, there can be achieved a prepreg with an excellent flexibility, a low warpage and a high strength.

These fiber base materials may also be heated and/or subjected to a surface treatment with a silane coupling agent or the like, for the purpose of improving dielectric properties and improving an affinity for resin.

There are no particular restrictions on the amount of the cyclic imide resin composition contained in the prepreg; it is preferred that the composition be contained by an amount of 20 to 90% by volume, more preferably 30 to 80% by volume, even more preferably 40 to 70% by volume. When the amount of the cyclic imide resin composition is within these ranges, an adhesion strength to a conductor can be improved while maintaining dielectric properties and a low warpage.

There are no particular restrictions on the thickness of the prepreg of the present invention; it is preferred that the thickness thereof be 10 to 500 μm, more preferably 25 to 300 μm, even more preferably 40 to 200 μm. When the thickness of the prepreg is within these ranges, a copper-clad laminate can be favorably produced.

The prepreg of the present invention may be previously semi-cured (B-staged) by heat. There are no particular restrictions on a method for turning the prepreg into B-stage; for example, after dissolving the cyclic imide resin composition of the present invention into a solvent, impregnating a fiber base material with the solution thus prepared, and then drying the fiber base material, B-stage can be achieved by performing heating at 80 to 200° C. for 1 to 30 min.

### Copper-Clad Laminate

The prepreg of the present invention may also be used as a copper-clad laminate by laminating a copper foil thereon and pressurizing them so as to heat and cure the same. There are no particular restrictions on a method for producing the copper-clad laminate; for example, 1 to 20, preferably 2 to 10 pieces of the prepreg may be used with the copper foil being arranged on one or both surfaces of each of these pieces, the pieces of the prepreg and the copper foils are then pressurized so as to be heated and cured, thereby obtaining a copper-clad laminate.

There are no particular restrictions on the thickness of the copper foil; it is preferred that the thickness thereof be 3 to 70 μm, more preferably 10 to 50 μm, even more preferably 15 to 40 μm. When the thickness of the copper foil is within these ranges, there can be molded a multi-layered copper-clad laminate maintaining a high reliability.

There are no particular restrictions on a molding condition(s) for the copper-clad laminate; for example, a multistage press machine, a multistage vacuum press machine, a continuous molding machine, an autoclave molding machine or the like may be used, where molding may for example be performed at a temperature of 100 to 400° C. and a pressure of 1 to 100 MPa for a heating period of 0.1 to 4 hours. Further, a copper-clad laminate can also be molded by combining and molding together the prepreg of the present invention, the copper foil and a wiring board for inner layer.

### Printed-Wiring Board

The copper-clad laminate of the present invention may also be used as a printed-wiring board after undergoing a circuit processing.

There are no particular restrictions on the circuit processing method; there may be employed a circuit formation processing method utilizing, for example, a drilling process, a metal plating process and/or a metal foil etching process.

Further, the printed-wiring board may also be produced by a build-up method where the resin composition and prepreg of the present invention as well as the copper foil are to be sequentially laminated on top of one another.

### Working Examples

The present invention is described in greater detail hereunder with reference to working and comparative examples; the present invention shall not be limited to the following working examples.

The molecular weight mentioned hereunder is a weight-average molecular weight (Mw) measured by gel permeation chromatography (GPC) with polystyrene being used as a reference substance. The measurement conditions are shown below.

GPC measurement conditions
Developing solvent: Tetrahydrofuran
Flow rate: 0.6 mL/min

### Column: TSK Guardcolumn Super H-L

TSK gel Super H4000 (6.0 mmI.D.×15 cm×1)

TSK gel Super H3000 (6.0 mmI.D.×15 cm×1)

TSK gel Super H2000 (6.0 mmI.D.×15 cm×2)

(All manufactured by TOSOH CORPORATION)

Column temperature: 40° C.
Sample injection volume: 20 μL (sample concentration: tetrahydrofuran solution of 0.5% by mass)
Detector: Refractive index detector (RI)
(a) Cyclic imide compound

(a-1) Maleimide compound

Here, 200 g of 1,12-diaminododecane (1.0 mol) and 207 g of pyromellitic anhydride (0.95 mol) were added to 196 g of N-methylpyrrolidone, followed by stirring them at 25° C. for three hours, and then at 150° C. for another three hours. Further, 196 g of maleic anhydride (2.0 mol), 82 g of sodium acetate (1.0 mol) and 204 g of acetic anhydride (2.0 mol) were added to the solution thus obtained, followed by stirring them at 80° C. for an hour. Next, 500 g of toluene was added thereto; after performing water washing, dehydration, and then distilling away the solvent under a reduced pressure, a bismaleimide (a-1) represented by the following formula was obtained (weight-average molecular weight 3,500).

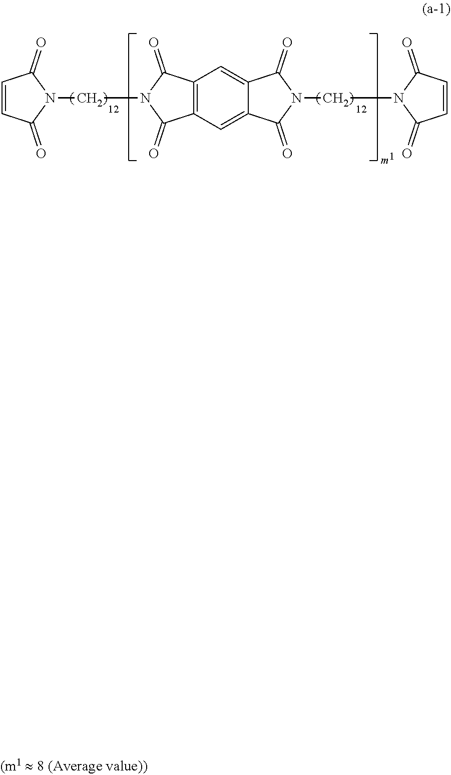

(a-2) Maleimide compound

Here, 158 g of 2,4,4-trimethylhexane-1,6-diamine (1.0 mol) and 214 g of pyromellitic anhydride (0.99 mol) were added to 361 g of N-methylpyrrolidone, followed by stirring them at 25° C. for three hours, and then at 150° C. for another 10 hours. Further, 196 g of maleic anhydride (2.0 mol), 82 g of sodium acetate (1.0 mol) and 204 g of acetic anhydride (2.0 mol) were added to the solution thus obtained, followed by stirring them at 80° C. for an hour. Next, 1,000 g of toluene was added thereto; after performing water washing, dehydration, and then distilling away the solvent under a reduced pressure, a bismaleimide (a-2) represented by the following formula was obtained (weight-average molecular weight 95,000).

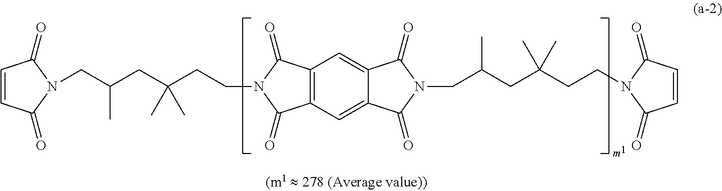

(a-3) Maleimide compound

Here, 170 g of isophoronediamine (1.0 mol) and 499 g of 4,4′-(4,4′-isopropylidenediphenoxy)diphthalic anhydride (0.96 mol) were added to 263 g of N-methylpyrrolidone, followed by stirring them at 25° C. for three hours, and then at 150° C. for another five hours. Further, 196 g of maleic anhydride (2.0 mol), 82 g of sodium acetate (1.0 mol) and 204 g of acetic anhydride (2.0 mol) were added to the solution thus obtained, followed by stirring them at 80° C. for an hour. Next, 500 g of toluene was added thereto; after performing water washing, dehydration, and then distilling away the solvent under a reduced pressure, a bismaleimide (a-3) represented by the following formula was obtained (weight-average molecular weight 20,000).

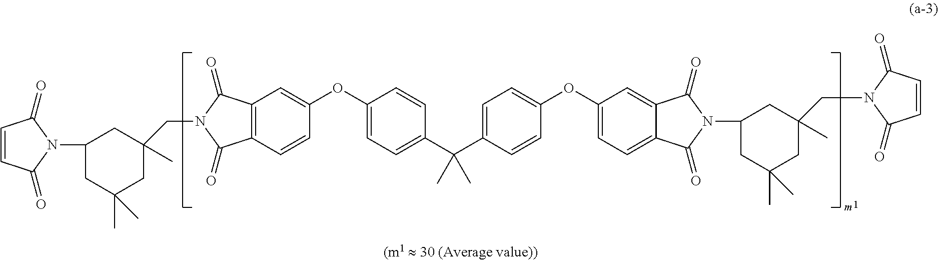

(a-4) Citraconimide compound

Here, 523 g of dimer diamine (1.0 mol) and 211 g of pyromellitic anhydride (0.97 mol) were added to 263 g of N-methylpyrrolidone, followed by stirring them at 25° C. for three hours, and then at 150° C. for another five hours. Further, 226 g of citraconic anhydride (2.0 mol), 82 g of sodium acetate (1.0 mol) and 204 g of acetic anhydride (2.0 mol) were added to the solution thus obtained, followed by stirring them at 80° C. for an hour. Next, 500 g of toluene was added thereto; after performing water washing, dehydration, and then distilling away the solvent under a reduced pressure, a citraconimide (a-4) represented by the following formula was obtained (weight-average molecular weight 10,000).

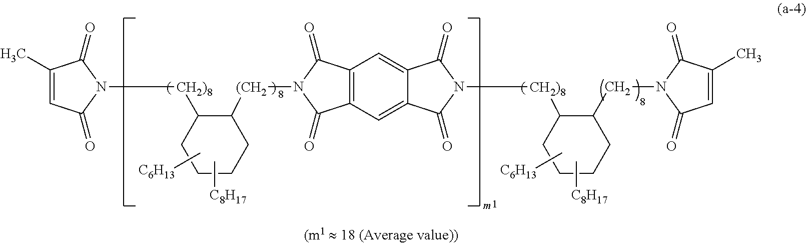

(a-5) Maleimide compound

Maleimide compound represented by the following formula (BMI-2500 by Designer Molecules Inc.) (weight-average molecular weight 3,500)

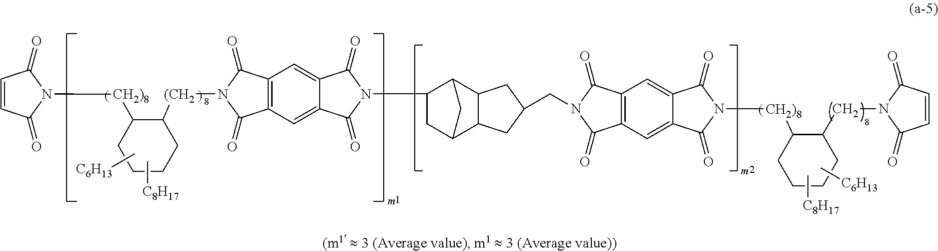

(a-6) Maleimide compound

Maleimide compound represented by the following formula (BMI-3000 by Designer Molecules Inc.) (weight-average molecular weight 10,000)

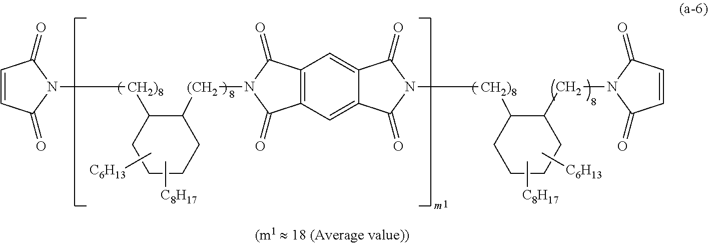

(a-7) Maleimide compound

Here, 327 g of 3,3′5,5′-tetraethyl-4,4′-diaminodiphenylmethane (1.05 mol) and 310 g of 4,4′-oxydiphthalic anhydride (1.0 mol) were added to 350 g of anisole, followed by stirring them at room temperature for three hours, and then at 120° C. for another three hours. Further, 19 g of maleic anhydride (0.2 mol) was added to the solution thus obtained, followed by stirring them at 150° C. for an hour. Next, the solvent and unreacted maleic anhydride were distilled away under a reduced pressure to obtain a maleimide (a-7) represented by the following formula (weight-average molecular weight 58,000).

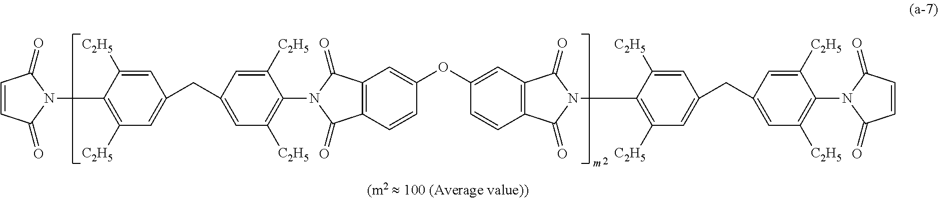

(a-8) Maleimide compound

Here, 431 g of 2,2-bis(4-(4-aminophenoxy)phenyl)propane (1.05 mol) and 520 g of 4,4′-(4,4′-isopropylidenediphenoxy)diphthalic anhydride (1.0 mol) were added to 500 g of anisole, followed by stirring them at room temperature for five hours, and then at 120° C. for another three hours. Further, 19 g of maleic anhydride (0.2 mol) was added to the solution thus obtained, followed by stirring them at 150° C. for an hour. Next, the solvent and unreacted maleic anhydride were distilled away under a reduced pressure to obtain a maleimide (a-8) represented by the following formula (weight-average molecular weight 45,000).

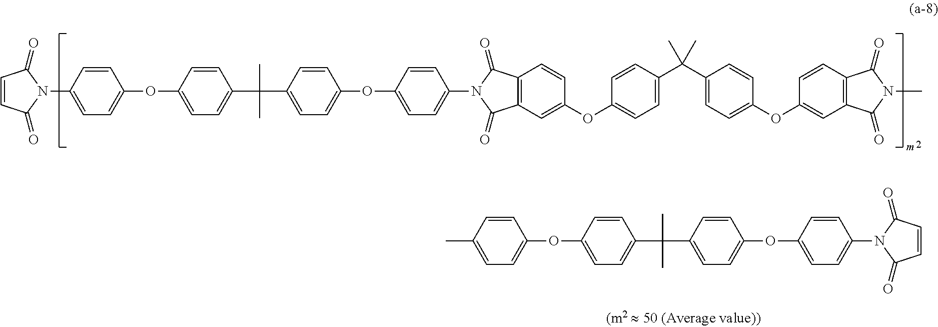

(a-9) Maleimide compound

Here, 155 g of 3,3′,5,5′-tetraethyl-4,4′-diaminodiphenylmethane (0.5 mol), 277 g of Priamine 1075 (by Croda Japan K.K.) (0.5 mol) and 310 g of 4,4′-oxydiphthalic anhydride (1.0 mol) were added to 400 g of anisole, followed by stirring them at room temperature for five hours, and then at 120° C. for another 12 hours. Further, 19 g of maleic anhydride (0.2 mol) was added to the solution thus obtained, followed by stirring them at 150° C. for an hour. Next, the solvent and unreacted maleic anhydride were distilled away under a reduced pressure to obtain a maleimide (a-9) represented by the following formula (weight-average molecular weight

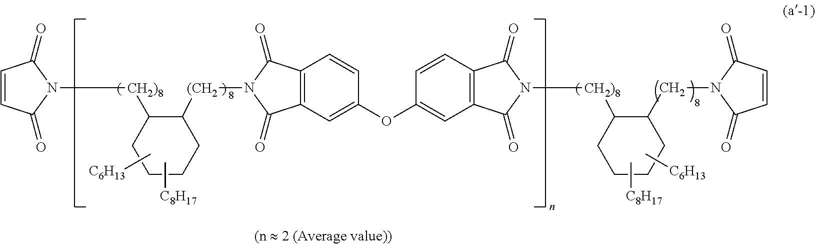

(a′-1) Maleimide compound (for comparative example)

Maleimide compound represented by the following formula (BMI-1500 by Designer Molecules Inc.) (weight-average molecular weight 1,800)

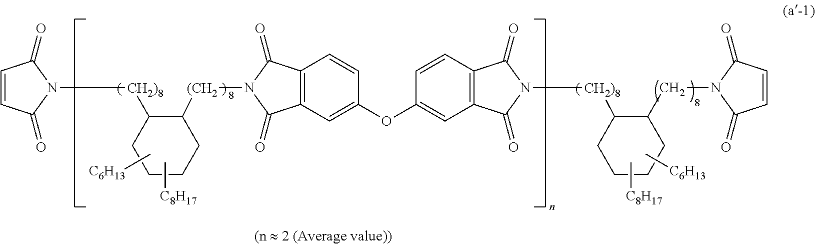

(a′-2) Maleimide compound (for comparative example)

Maleimide compound represented by the following formula (BMI-2300 by Daiwakasei Industry Co., LTD.) (weight-average molecular weight 400)

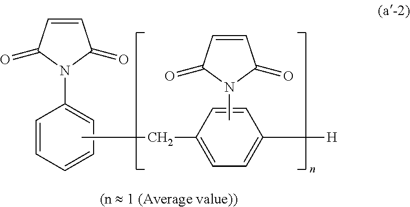

(a′-3) Maleimide compound (for comparative example)

Maleimide compound represented by the following formula (BMI-4000 by Daiwakasei Industry Co., LTD.) (weight-average molecular weight 570)

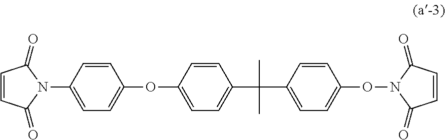 [SMILES: CC(C)(c1ccc(Oc2ccc(N3C(=O)C=CC3=O)cc2)cc1)c1ccc(ON2C(=O)C=CC2=O)cc1]

(b) Epoxy resin

(b-1) Phenoxy type epoxy resin (jER-1001 by Mitsubishi Chemical Corporation, epoxy equivalent 475 g/eq)

(b-2) Phenoxy type epoxy resin (jER-1010 by Mitsubishi Chemical Corporation, epoxy equivalent 4,000 g/eq)

(b-3) Biphenyl aralkyl type epoxy resin (NC-3000 by Nippon Kayaku Co., Ltd., epoxy equivalent 280 g/eq)

(b-4) Bisphenol A type epoxy resin (jER-828EL by Mitsubishi Chemical Corporation, epoxy equivalent 190 g/eq)

(c) Curing catalyst

(c-1-1) Dicumylperoxide

(c-1-2) t-butylcumylperoxide

(c-2-1) 2,4-diamino-6-[2-(2-methyl-1-imidazolyl)ethyl]-1,3,5-triazine (2MZ-A by SHIKOKU CHEMICALS CORPORATION)

(c-2-2) Bis(tetrabutylphosphonium)dihydrogen pyromellitate (BTBP-pyromellitate by HOKKO CHEMICAL INDUSTRY CO., LTD.)

(c-2-3) Triphenylphosphine

(d) Inorganic filler

(d-1) Silica “SFP-130MC” (median diameter of primary particle size 0.6 μm) (by Denka Company Limited)

(d-2) Alumina “A0-41R” (median diameter of primary particle size 6 μm) (by Admatechs Company Limited)

(e) Organic filler

(e-1) Silicone powder “KMP-600” (median diameter of primary particle size 5 μm) (by Shin-Etsu Chemical Co., Ltd.)

(f) Adhesiveness imparting agent

(f-1) Silane coupling agent (3-glycidoxypropyltrimethoxysilane, “KBM-403” by Shin-Etsu Chemical Co., Ltd.)

(f-2) Silane coupling agent (N-phenyl-3-aminopropyltrimethoxysilane, “KBM-573” by Shin-Etsu Chemical Co., Ltd.)

### (g) Antioxidant

(g-1) Pentaerythritol tetrakis[3-(3,5-di-t-butyl-4-hydroxyphenyl)propionate] (ADK STAB AO-60 by ADEKA CORPORATION)

(h) Flame retardant

(h-1) Guanidine phosphate (APINON-303 by SANWA Chemical Co., Ltd) Preparation method of resin composition

As for each of working examples 1 to 22 and comparative examples 1 to 6, in addition to the ingredients (parts by mass) shown in Tables 1 to 3, 100 parts by mass of cyclopentanone were added with respect to a total of 100 parts by mass of all the ingredients in each example, followed by mixing them, and using a planetary mixer (by INOUE MFG., INC.) to perform kneading at 80° C. for 30 min before cooling the kneaded solution to 25° C. The solution thus obtained was then moved to a flask, followed by distilling away the solvent under a reduced pressure to obtain a resin composition.

### Tensile Strength and Elongation at Break of Cured Product

The uncured resin composition obtained in each of the working examples 1 to 22 and comparative examples 1 to 6 was subjected to press curing at 200° C. for an hour so as to produce a test sample (cured product) having a size of 150 mm×200 mm x thickness 50 μm. In accordance with JIS K 6251:2010, the tensile strength (MPa) and elongation at break (%) of the test sample (cured product) were then measured using EZ TEST (EZ-L by SHIMADZU CORPORATION), at a testing rate of 500 mm/min, an inter-gripper length of 80 mm and a gauge length of 40 mm. The results thereof are shown in Tables 1 to 3.

### Relative Permittivity and Dielectric Tangent

The uncured resin composition prepared was fitted into a molding frame of 30 mm×40 mm×thickness 100 μm, and was then subjected to press curing at 200° C. for an hour to produce a test sample (cured product). A network analyzer (E5063-2D5 by Keysight Technologies) and a stripline (by KEYCOM Corporation) were then connected to the test sample (cured product) produced to measure a relative permittivity and dielectric tangent thereof at a frequency of 10 GHz. The results thereof are shown in Tables 1 to 3. Peeling strength

The uncured resin composition prepared by the above method was applied so as to be turned into the shape of a film having a thickness of 25 μm. A SUS plate, this film and a copper foil having a thickness of 18 μm (TQ-M4-VSP by MITSUI MINING & SMELTING CO., LTD.) were then sequentially laid on top of one another in this order before being pressed and heated at 200° C. for an hour so as to be cured. In accordance with JIS-C-6481:1996 which is a standard for “Test methods of copper-clad laminates for printed wiring boards,” and with the aid of a tensile tester (STROGRAPH VE-1D by Toyo Seiki Seisaku-sho, Ltd.), there was measured a force (kN/m) at which the copper foil was peeled away from the resin film at a rate of 50 mm/min and at an angle of 90° in a width of 10 mm. The results thereof are shown in Tables 1 to 3.

### Glass-Transition Temperature

A storage elastic modulus (MPa) of the test sample (cured product) produced in the manner as described in [Tensile strength and elongation at break of cured product], was measured by DMA Q800 (by TA Instruments) in a range of 0 to 300° C. A value of Tan 8 derived from the values of the storage elastic modulus obtained and a loss elastic modulus was then plotted on a graph, where a temperature at a peak top in the graph was regarded as a glass-transition temperature (Tg). The measurement was performed under conditions of: test sample (cured product) of a size of 20 mm×5 mm x thickness 50 μm; rate of temperature rise 5° C./min; multifrequency mode; tensile mode; amplitude 15 μm. The results thereof are shown in Tables 1 to 3.

### Fast Curability

The uncured resin composition obtained in each of the working examples 1 to 22 and comparative examples 1 to 6 was pressed at 150° C. for 3 min, where “o” was given to examples in which the composition cured, and “x” was given to examples in which the composition did not cure. The results thereof are shown in Tables 1 to 3.

TABLE 1

| | | | Working | Working | Working | Working | Working |
|---|---|---|---|---|---|---|---|
| | | | example | example | example | example | example |
| | | | 1 | 2 | 3 | 4 | 5 |
| (a) | (a-1) | | 100 | | | | |
| | (a-2) | | | 100 | | | |
| | (a-3) | | | | 100 | | |
| | (a-4) | | | | | 100 | |
| | (a-5) | | | | | | 100 |
| | (a-6) | | | | | | |
| | (a-7) | | | | | | |
| | (a-8) | | | | | | |
| | (a-9) | | | | | | |
| | (a′-1) | | | | | | |
| | (a′-2) | | | | | | |
| | (a′-3) | | | | | | |
| (b) | (b-1) | | 10 | 3 | 5 | 7 | |
| | (b-2) | | | | | | 5 |
| | (b-3) | | | | | | |
| | (b-4) | | | | | | |
| (c) | (c-1-1) | | 1 | 1 | 1 | 5 | |
| | (c-1-2) | | | | | | 2 |
| | (c-2-1) | | 1 | | | | |
| | (c-2-2) | | | 2 | | 5 | |
| | (c-2-3) | | | | 1 | | 2 |
| (d) | (d-1) | | | | | | |
| | (d-2) | | | | | | |
| (e) | (e-1) | | | | | | |
| (f) | (f-1) | | | | | | |
| | (f-2) | | | | | | |
| (g) | (g-1) | | | | | | |
| (h) | (h-1) | | | | | | |
| Evaluation | Tensile | MPa | 20 | 30 | 40 | 10 | 40 |
| result | strength | | | | | | |
| | Elongation | % | 120 | 180 | 20 | 200 | 60 |
| | at break | | | | | | |
| | Relative | | 2.6 | 2.6 | 2.8 | 2.5 | 2.5 |
| | permittivity | | | | | | |
| | (10 GHz) | | | | | | |
| | Dielectric | | 0.003 | 0.003 | 0.003 | 0.002 | 0.002 |
| | tangent | | | | | | |
| | (10 GHz) | | | | | | |
| | Peeling | kN/m | 1.2 | 1.2 | 1.3 | 1.8 | 1.6 |
| | strength | | | | | | |
| | Glass- | ° C. | 80 | 150 | 180 | 40 | 80 |
| | transition | | | | | | |
| | temperature | | | | | | |
| | Fast | | ∘ | ∘ | ∘ | ∘ | ∘ |
| | curability | | | | | | |
| | | | Working | Working | Working | Working | Working |
| | | | example | example | example | example | example |
| | | | 6 | 7 | 8 | 9 | 10 |
| (a) | (a-1) | | | | | | 100 |
| | (a-2) | | | | | | |
| | (a-3) | | | | | | |
| | (a-4) | | | | | | |
| | (a-5) | | | | | | |
| | (a-6) | | 100 | | | | |
| | (a-7) | | | 100 | | | |
| | (a-8) | | | | 100 | | |
| | (a-9) | | | | | 100 | |
| | (a′-1) | | | | | | |
| | (a′-2) | | | | | | |
| | (a′-3) | | | | | | |
| (b) | (b-1) | | | | | 3 | 40 |
| | (b-2) | | 3 | 3 | 10 | | |
| | (b-3) | | | | | | |
| | (b-4) | | | | | | |
| (c) | (c-1-1) | | | | | | 1 |
| | (c-1-2) | | 0.5 | 1 | 3 | 2 | |
| | (c-2-1) | | | 1 | | 2 | 1 |
| | (c-2-2) | | 2 | | 2 | | |
| | (c-2-3) | | | | | | |
| (d) | (d-1) | | | | | | |
| | (d-2) | | | | | | |
| (e) | (e-1) | | | | | | |
| (f) | (f-1) | | | | | | |
| | (f-2) | | | | | | |
| (g) | (g-1) | | | | | | |
| (h) | (h-1) | | | | | | |
| Evaluation | Tensile | MPa | 20 | 80 | 70 | 70 | 30 |
| result | strength | | | | | | |
| | Elongation | % | 210 | 10 | 10 | 20 | 100 |
| | at break | | | | | | |
| | Relative | | 2.5 | 2.9 | 2.8 | 2.7 | 3.0 |
| | permittivity | | | | | | |
| | (10 GHz) | | | | | | |
| | Dielectric | | 0.002 | 0.004 | 0.004 | 0.004 | 0.005 |
| | tangent | | | | | | |
| | (10 GHz) | | | | | | |
| | Peeling | kN/m | 1.8 | 0.9 | 0.8 | 0.8 | 1.5 |
| | strength | | | | | | |
| | Glass- | ° C. | 40 | 220 | 200 | 180 | 100 |
| | transition | | | | | | |
| | temperature | | | | | | |
| | Fast | | ∘ | ∘ | ∘ | ∘ | ∘ |
| | curability | | | | | | |

TABLE 2

| | | | Working | Working | Working | Working | Working |
|---|---|---|---|---|---|---|---|
| | | | example | example | example | example | example |
| | | | 11 | 12 | 13 | 14 | 15 |
| (a) | (a-1) | | 100 | 100 | 100 | | |
| | (a-2) | | | | | 40 | |
| | (a-3) | | | | | 10 | |
| | (a-4) | | | | | 50 | 60 |
| | (a-5) | | | | | | 40 |
| | (a-6) | | | | | | |
| | (a-7) | | | | | | |
| | (a-8) | | | | | | |
| | (a-9) | | | | | | |
| | (a′-1) | | | | | | |
| | (a′-2) | | | | | | |
| | (a′-3) | | | | | | |
| (b) | (b-1) | | | | | 8 | 5 |
| | (b-2) | | 10 | | | | 5 |
| | (b-3) | | | 10 | | | |
| | (b-4) | | | | 10 | | |
| (c) | (c-1-1) | | 1 | 2 | 2 | | |
| | (c-1-2) | | | | | 2 | 2 |
| | (c-2-1) | | | 1 | 1 | | |
| | (c-2-2) | | 2 | | | 1 | 1 |
| | (c-2-3) | | | | | | 1 |
| (d) | (d-1) | | | | | | |
| | (d-2) | | | | | | |
| (e) | (e-1) | | | | | | |
| (f) | (f-1) | | | | | | |
| | (f-2) | | | | | | |
| (g) | (g-1) | | | | | | |
| (h) | (h-1) | | | | | | |
| Evaluation | Tensile | MPa | 20 | 20 | 20 | 25 | 15 |
| result | strength | | | | | | |
| | Elongation | % | 120 | 120 | 120 | 150 | 100 |
| | at break | | | | | | |
| | Relative | | 2.6 | 2.7 | 2.7 | 2.6 | 2.6 |
| | permittivity | | | | | | |
| | (10 GHz) | | | | | | |
| | Dielectric | | 0.003 | 0.005 | 0.005 | 0.003 | 0.003 |
| | tangent | | | | | | |
| | (10 GHz) | | | | | | |
| | Peeling | kN/m | 1.3 | 1.3 | 1.3 | 1.2 | 1.2 |
| | strength | | | | | | |
| | Glass- | ° C. | 80 | 150 | 160 | 120 | 60 |
| | transition | | | | | | |
| | temperature | | | | | | |
| | Fast | | ∘ | ∘ | ∘ | ∘ | ∘ |
| | curability | | | | | | |
| | | | Working | Working | Working | Working | Working |
| | | | example | example | example | example | example |
| | | | 16 | 17 | 18 | 19 | 20 |
| (a) | (a-1) | | | | 50 | 60 | 100 |
| | (a-2) | | | | | | |
| | (a-3) | | | | | | |
| | (a-4) | | | 100 | | | |
| | (a-5) | | | | | 40 | |
| | (a-6) | | | | 50 | | |
| | (a-7) | | 100 | | | | |
| | (a-8) | | | | | | |
| | (a-9) | | | | | | |
| | (a′-1) | | | | | | |
| | (a′-2) | | | | | | |
| | (a′-3) | | | | | | |
| (b) | (b-1) | | | 5 | 5 | 10 | 20 |
| | (b-2) | | 10 | 5 | | | |
| | (b-3) | | | | | | |
| | (b-4) | | | | | | |
| (c) | (c-1-1) | | 1 | | 1 | | 2 |
| | (c-1-2) | | 1 | 1 | | 2 | |
| | (c-2-1) | | 1 | 1 | | | 1 |
| | (c-2-2) | | | 1 | | 2 | |
| | (c-2-3) | | | 1 | 1 | | |
| (d) | (d-1) | | | | 50 | | |
| | (d-2) | | | | | 100 | |
| (e) | (e-1) | | | | | | 10 |
| (f) | (f-1) | | | | 1 | | |
| | (f-2) | | | | | 2 | |
| (g) | (g-1) | | | | | | |
| (h) | (h-1) | | | | | | |
| Evaluation | Tensile | MPa | 80 | 10 | 50 | 60 | 20 |
| result | strength | | | | | | |
| | Elongation | % | 5 | 200 | 5 | 30 | 120 |
| | at break | | | | | | |
| | Relative | | 2.9 | 2.5 | 2.8 | 3.5 | 2.6 |
| | permittivity | | | | | | |
| | (10 GHz) | | | | | | |
| | Dielectric | | 0.004 | 0.002 | 0.001 | 0.001 | 0.002 |
| | tangent | | | | | | |
| | (10 GHz) | | | | | | |
| | Peeling | kN/m | 0.8 | 1.3 | 1.2 | 1.1 | 1.2 |
| | strength | | | | | | |
| | Glass- | ° C. | 220 | 40 | 50 | 60 | 80 |
| | transition | | | | | | |
| | temperature | | | | | | |
| | Fast | | ∘ | ∘ | ∘ | ∘ | ∘ |
| | curability | | | | | | |

TABLE 3

| | | | Working | Working | Comparative | Comparative | Comparative | Comparative | Comparative | Comparative |
|---|---|---|---|---|---|---|---|---|---|---|
| | | | example | example | example | example | example | example | example | example |
| | | | 21 | 22 | 1 | 2 | 3 | 4 | 5 | 6 |
| (a) | (a-1) | | | 100 | 100 | 100 | 100 | | | |
| | (a-2) | | | | | | | | | |
| | (a-3) | | | | | | | | | |
| | (a-4) | | 80 | | | | | | | |
| | (a-5) | | | | | | | | | |
| | (a-6) | | 20 | | | | | | | |
| | (a-7) | | | | | | | | | |
| | (a-8) | | | | | | | | | |
| | (a-9) | | | | | | | | | |
| | (a′-1) | | | | | | | 100 | | |
| | (a′-2) | | | | | | | | 100 | |
| | (a′-3) | | | | | | | | | 100 |
| (b) | (b-1) | | | | | 10 | 10 | 10 | 10 | 10 |
| | (b-2) | | 10 | 10 | | | | | | |
| | (b-3) | | | | | | | | | |
| | (b-4) | | | | | | | | | |
| (c) | (c-1-1) | | | 1 | 1 | 1 | | 2 | | 2 |
| | (c-1-2) | | 2 | | | | | | 2 | |
| | (c-2-1) | | | | 1 | | 1 | 2 | 2 | |
| | (c-2-2) | | 2 | | | | | | | 2 |
| | (c-2-3) | | | 3 | | | | | | |
| (d) | (d-1) | | | | | | | | | |
| | (d-2) | | | | | | | | | |
| (e) | (e-1) | | | | | | | | | |
| (f) | (f-1) | | | | | | | | | |
| | (f-2) | | | | | | | | | |
| (g) | (g-1) | | 1 | | | | | | | |
| (h) | (h-1) | | | 5 | | | | | | |
| Evaluation | Tensile | MPa | 10 | 20 | 20 | 20 | 20 | 5 | 60 | 50 |
| result | strength | | | | | | | | | |
| | Elongation | % | 180 | 120 | 120 | 120 | 100 | 30 | 5 | 5 |
| | at break | | | | | | | | | |
| | Relative | | 2.6 | 2.5 | 2.6 | 2.6 | 2.6 | 2.5 | 3.1 | 3.0 |
| | permittivity | | | | | | | | | |
| | (10 GHz) | | | | | | | | | |
| | Dielectric | | 0.002 | 0.002 | 0.002 | 0.003 | 0.003 | 0.002 | 0.02 | 0.015 |
| | tangent | | | | | | | | | |
| | (10 GHz) | | | | | | | | | |
| | Peeling | kN/m | 1.3 | 1.3 | 0.6 | 0.6 | 0.9 | 0.7 | 0.3 | 0.4 |
| | strength | | | | | | | | | |
| | Glass- | ° C. | 40 | 80 | 80 | 70 | 70 | 20 | 250 | 260 |
| | transition | | | | | | | | | |
| | temperature | | | | | | | | | |
| | Fast | | ∘ | ∘ | ∘ | x | x | ∘ | ∘ | ∘ |
| | curability | | | | | | | | | |

In each of the working examples 1 to 22, the cured product exhibited a low relative permittivity and a low dielectric tangent as well as a high peeling strength, and the composition had a fast curability.

In the comparative example 1, since the component (b) was not contained, a low peeling strength was exhibited.

In the comparative example 2, since the component (c-2) was not contained, the epoxy compound as the component (b) failed to cure, and a lower peeling strength was also exhibited.

In the comparative example 3, since the component (c-1) was not contained, the composition failed to cure under the curing condition of 150° C. for 3 min, and a lower peeling strength was also exhibited.

In the comparative example 4, since the molecular weight of the component (a) was so small that it was smaller than 2,000, the cured product exhibited a low tensile strength and a lower peeling strength.

In the comparative examples 5 and 6, since the molecular weight of the component (a) was so small that it was smaller than 2,000, and since the cured product had a low flexibility, a lower peeling strength was exhibited.

What is claimed:

1. A cyclic imide resin composition comprising:
(a) a cyclic imide compound represented by the following formula (1) and having a weight-average molecular weight of 2,000 to 1,000,000, 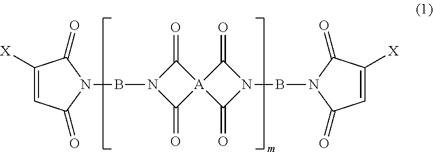
wherein A independently represents a tetravalent organic group having a cyclic structure, B independently represents a divalent hydrocarbon group that may contain a hetero atom and has not less than six carbon atoms, X independently represents a hydrogen atom or a methyl group, m is 1 to 1,000;
(b) an epoxy compound; and
(c) a polymerization initiator containing at least two types of polymerization initiators which are a radical polymerization initiator (c-1) and an anionic polymerization initiator (c-2).

2. The cyclic imide resin composition according to claim 1, wherein the organic group represented by A in the formula (1) is any one of the tetravalent organic groups expressed by the following structural formulae: 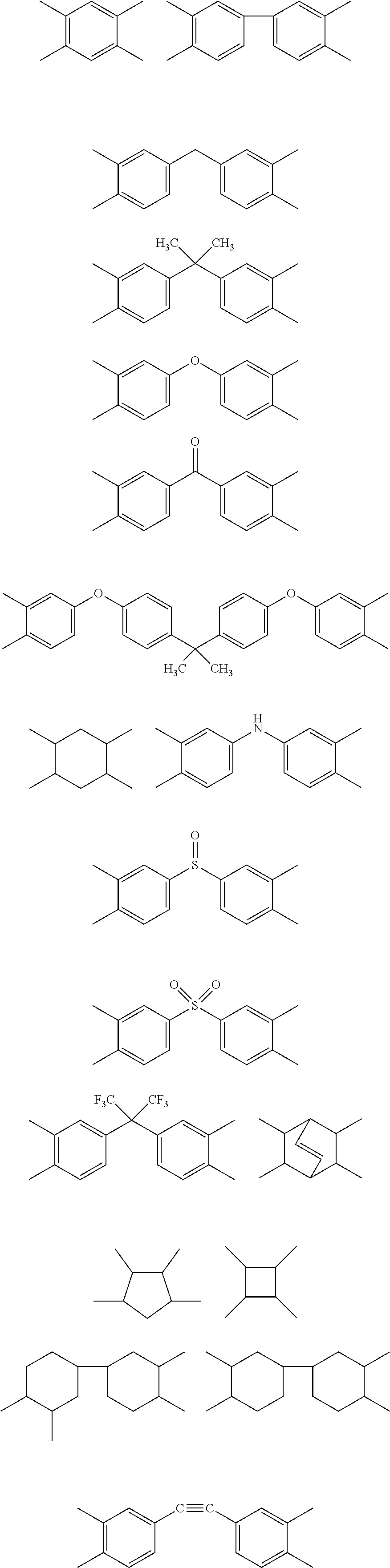
wherein bonds that are yet unbonded to substituent groups are to be bonded to carbonyl carbons forming cyclic imide structures in the formula (1).

3. The cyclic imide resin composition according to claim 1, wherein the cyclic imide compound as the component (a) is a cyclic imide compound represented by the following formula (2): 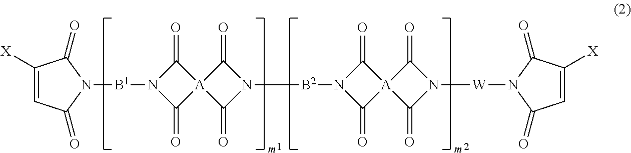
wherein A independently represents a tetravalent organic group having a cyclic structure; B¹ independently represents an alkylene group that may contain a hetero atom and has 6 to 60 carbon atoms, or a dimer acid frame-derived divalent hydrocarbon group; B² independently represents an arylene group that may contain a hetero atom and has 6 to 30 carbon atoms; X independently represents a hydrogen atom or a methyl group; W is B¹ or B²; m¹ is 1 to 500; m² is 0 to 500.

4. The cyclic imide resin composition according to claim 3, wherein B¹ in the formula (2) is selected from a dimer acid frame-derived divalent hydrocarbon group and any of the groups represented by the following structural formulae: 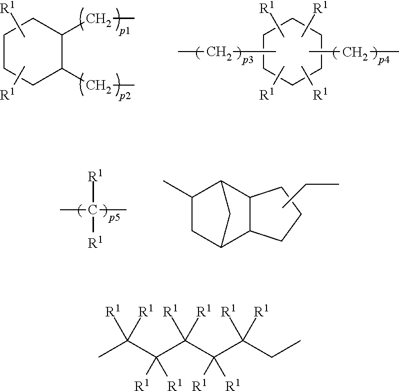
wherein each R¹ independently represents a hydrogen atom, or a linear or branched alkyl group having 1 to 20 carbon atoms; p¹ and p² each represent a number of not smaller than 5, and may be either identical to or different from each other; p³ and p⁴ each represent a number of not smaller than 0, and may be either identical to or different from each other; p⁵ represents a number of 6 to 60; bonds that are yet unbonded to substituent groups are to be bonded to nitrogen atoms forming cyclic imide structures in the formula (2).

5. The cyclic imide resin composition according to claim 3, wherein the arylene group that may contain a hetero atom and has 6 to 30 carbon atoms, as represented by B² in the formula (2), is a group expressed by any of the following structural formulae: 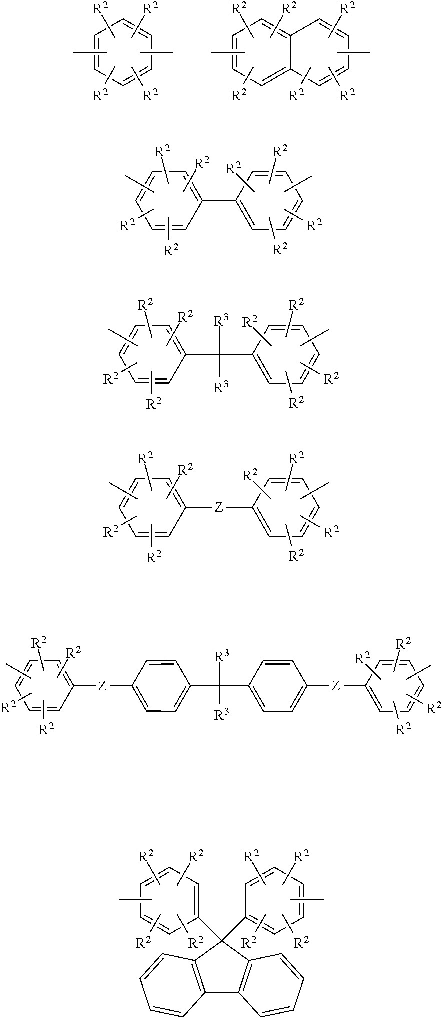
wherein each R² independently represents a hydrogen atom, a halogen atom or an alkyl group having 1 to 6 carbon atoms; each R³ independently represents a hydrogen atom, a halogen atom, a methyl group or a trifluoromethyl group; Z represents an oxygen atom, a sulfur atom or a methylene group; bonds that are yet unbonded to substituent groups are to be bonded to nitrogen atoms forming cyclic imide structures in the formula (2).

6. The cyclic imide resin composition according to claim 3, wherein the cyclic imide compound as the component (a) is a cyclic imide compound with m² in the formula (2) being 0.

7. The cyclic imide resin composition according to claim 6, wherein the epoxy compound as the component (b) has an epoxy equivalent of not smaller than 300 g/eq.

8. The cyclic imide resin composition according to claim 1, wherein the radical polymerization initiator as the component (c-1) is an organic peroxide.

9. The cyclic imide resin composition according to claim 1, wherein the anionic polymerization initiator as the component (c-2) is at least one compound selected from imidazole compounds and organic phosphorus compounds.

10. A liquid adhesive containing the cyclic imide resin composition according to claim 1.

11. A film containing the cyclic imide resin composition according to claim 1.

12. A prepreg containing the cyclic imide resin composition according to claim 1.

13. A copper-clad laminate containing the prepreg according to claim 12.

14. A printed-wiring board containing the copper-clad laminate according to claim 13.
